(19) United States
(12) Patent Application Publication
(10) Pub. No.: US 2025/0136240 A1
(43) Pub. Date: May 1, 2025

(54) CONTROL DEVICE FOR HUMAN-POWERED VEHICLE

(71) Applicant: Shimano Inc., Osaka (JP)

(72) Inventors: Satoshi SHAHANA, Osaka (JP); Shota YONEKAWA, Osaka (JP)

(21) Appl. No.: 18/903,626

(22) Filed: Oct. 1, 2024

(30) Foreign Application Priority Data
Oct. 31, 2023 (JP) 2023-186517
Jan. 15, 2024 (JP) 2024-004181

(51) Int. Cl. B62M 6/50

(52) U.S. Cl. CPC B62M 6/50

(57) ABSTRACT

A control device is provided for a human-powered vehicle. The control device includes an electronic controller. The electronic controller is configured to control a motor that applies an assist force to the human-powered vehicle in one of a plurality of assist modes having different assist levels. The electronic controller is configured to change a current assist mode to a changed assist mode different from the current assist mode depending on the current assist mode in a case where a traveling condition regarding a traveling state of the human-powered vehicle is satisfied.

### CROSS-REFERENCE TO RELATED APPLICATIONS

This application claims priority to Japanese Patent Application No. 2023-186517 filed on Oct. 31, 2023, and Japanese Patent Application No. 2024-004181, filed on Jan. 15, 2024. The entire disclosures of Japanese Patent Application Nos. 2023-186517 and 2024-004181 are hereby incorporated herein by reference.

### BACKGROUND

### Technical Field

The present disclosure generally relates to a technology of a control device for a human-powered vehicle.

### Background Information

For example, Japanese Laid-Open Patent Publication No. 7-323880 A (Patent Document 1) discloses a control device that controls a motor for applying an assist force to a human-powered vehicle in accordance with a human driving force.

### SUMMARY

One object of the present disclosure is to provide a control device for a human-powered vehicle, the control device being capable of contributing to comfortable traveling of the human-powered vehicle.

In accordance with a first aspect of the present disclosure, a control device for a human-powered vehicle is provided that basically comprises an electronic controller. The electronic controller is configured to control a motor that applies an assist force to the human-powered vehicle, in one assist mode of a plurality of assist modes having assist levels different from one another. The electronic controller is further configured to change a current assist mode to a changed assist mode different from the current assist mode depending on the current assist mode in a case where a traveling condition regarding a traveling state of the human-powered vehicle is satisfied.

The control device for the human-powered vehicle of the first aspect can contribute to comfortable traveling of the human-powered vehicle.

In the control device for the human-powered vehicle of a second aspect according to the first aspect, each of the assist levels includes a maximum ratio of an output of the motor to a human driving force input to the human-powered vehicle.

According to the control device for the human-powered vehicle of the second aspect, the maximum ratio of the output of the motor can be changed depending on the current assist mode, which can further contribute to comfortable traveling of the human-powered vehicle.

In the control device for the human-powered vehicle of a third aspect according to the first or second aspect, the electronic controller is configured to change the current assist mode to the changed assist mode in accordance with information regarding the current assist mode and mode determination information.

According to the control device for the human-powered vehicle of the third aspect, the assist mode can be changed in accordance with the information regarding the current assist mode and the mode determination information, which can further contribute to comfortable traveling of the human-powered vehicle.

In the control device for the human-powered vehicle of a fourth aspect according to the third aspect, the mode determination information includes level increase information for determining the changed assist mode such that the assist level increases.

According to the control device for the human-powered vehicle of the fourth aspect, the assist level can be increased depending on the current assist mode, which can further contribute to comfortable traveling of the human-powered vehicle.

In the control device for the human-powered vehicle of a fifth aspect according to the fourth aspect, the traveling condition includes a first traveling condition satisfied in a case where at least one of a condition regarding a human driving force input to the human-powered vehicle, a condition regarding a traveling state of the human-powered vehicle, and a condition regarding a traveling environment of the human-powered vehicle is satisfied, and in a case where the first traveling condition is satisfied, the electronic controller is configured to change the current assist mode to the changed assist mode determined in accordance with the level increase information.

According to the control device for the human-powered vehicle of the fifth aspect, the assist level can be increased in a case where at least one of the condition regarding the human driving force, the condition regarding the traveling state of the human-powered vehicle, and the condition regarding the traveling environment of the human-powered vehicle is satisfied, which can further contribute to comfortable traveling of the human-powered vehicle.

In the control device for the human-powered vehicle of a sixth aspect according to any one of the fourth and fifth aspects, the level increase information includes at least one of first information regarding a human driving force input to the human-powered vehicle, second information regarding a traveling state of the human-powered vehicle, and third information regarding a traveling environment of the human-powered vehicle, and fourth information regarding an increase amount of the assist level.

According to the control device for the human-powered vehicle of the sixth aspect, the assist level can be increased in accordance with at least one of the first information, the second information, and the third information, and the fourth information, which can further contribute to comfortable traveling of the human-powered vehicle.

In the control device for the human-powered vehicle of a seventh aspect according to the sixth aspect, the first information includes at least one of information regarding a mean value of the human driving force in a case where a crank of the human-powered vehicle rotates a predetermined number of times and information regarding a maximum value of the human driving force in the case where the crank of the human-powered vehicle rotates the predetermined number of times.

According to the control device for the human-powered vehicle of the seventh aspect, the assist level can be increased in accordance with at least one of the information regarding the mean value of the human driving force and the information regarding the maximum value of the human driving force, which can further contribute to comfortable traveling of the human-powered vehicle.

In the control device for the human-powered vehicle of an eighth aspect according to the sixth or seventh aspect, the second information includes information regarding an inclination of the human-powered vehicle.

According to the control device for the human-powered vehicle of the eighth aspect, the assist level can be increased in accordance with the information regarding the inclination of the human-powered vehicle, which can further contribute to comfortable traveling of the human-powered vehicle.

In the control device for the human-powered vehicle of a ninth aspect according to any one of the sixth to eighth aspects, the third information includes information regarding an obliquity of a traveling passage of the human-powered vehicle.

According to the control device for the human-powered vehicle of the ninth aspect, the assist level can be increased in accordance with the information regarding the obliquity of the traveling passage of the human-powered vehicle, which can further contribute to comfortable traveling of the human-powered vehicle.

In the control device for the human-powered vehicle of a tenth aspect according to any one of the fourth to ninth aspects, in a case of increasing the assist level, the electronic controller directly changes the current assist mode to the changed assist mode not through an intermediate assist mode.

The control device for the human-powered vehicle of the tenth aspect can cope with the user's urgency, which can further contribute to comfortable traveling of the human-powered vehicle.

In the control device for the human-powered vehicle of an eleventh aspect according to any one of the fourth to tenth aspects, the electronic controller is configured to change the level increase information in accordance with an input from at least one of an operation device of an external device and an operation device provided to the human-powered vehicle.

The control device for the human-powered vehicle of the eleventh aspect can improve convenience.

In the control device for the human-powered vehicle of a twelfth aspect according to any one of the fourth to eleventh aspects, the electronic controller is configured not to change the assist mode such that the assist level increases in a case where a state in which a vehicle speed of the human-powered vehicle does not exceed a predetermined first threshold continues for a predetermined time.

According to the control device for the human-powered vehicle of the twelfth aspect, the assist mode can be maintained in a case where the human-powered vehicle continuously travels at a low speed, which can further contribute to comfortable traveling of the human-powered vehicle.

In the control device for the human-powered vehicle of a thirteenth aspect according to any one of the fourth to twelfth aspects, the electronic controller is configured to control a transmission device maintain a transmission gear ratio of the human-powered vehicle in a case where the assist mode is changed to increase the assist level.

According to the control device for the human-powered vehicle of the thirteenth aspect, the speed of the human-powered vehicle is easily maintained, which can further contribute to comfortable traveling of the human-powered vehicle.

In the control device for the human-powered vehicle of a fourteenth aspect according to any one of the fifth to thirteenth aspects, the mode determination information further includes level decrease information for determining the changed assist mode such that the assist level decreases.

According to the control device for the human-powered vehicle of the fourteenth aspect, the assist level can be decreased depending on the current assist mode, which can further contribute to comfortable traveling of the human-powered vehicle.

In the control device for the human-powered vehicle of a fifteenth aspect according to the fourteenth aspect, the traveling condition includes a second traveling condition different from the first traveling condition, and in a case where the second traveling condition is satisfied after the assist mode is changed such that the assist level increases, the electronic controller is configured to change the current assist mode to the changed assist mode determined in accordance with the level decrease information.

According to the control device for the human-powered vehicle of the fifteenth aspect, in a case where the second traveling condition is satisfied, the assist level that has been increased in accordance with the level increase information can be decreased, which can further contribute to comfortable traveling of the human-powered vehicle.

In the control device for the human-powered vehicle of a sixteenth aspect according to the fifteenth aspect, the second traveling condition is satisfied in a case where at least one of a condition regarding a human driving force input to the human-powered vehicle, a condition regarding a traveling state of the human-powered vehicle, and information regarding a traveling environment of the human-powered vehicle is satisfied.

According to the control device for the human-powered vehicle of the sixteenth aspect, in a case where at least one of the condition regarding the human driving force, the condition regarding the traveling state of the human-powered vehicle, and the information regarding the traveling environment of the human-powered vehicle is satisfied, the assist level can be decreased, which can further contribute to comfortable traveling of the human-powered vehicle.

In the control device for the human-powered vehicle of a seventeenth aspect according to any one of the fourteenth to sixteenth aspects, the level decrease information includes at least one of first information regarding a human driving force input to the human-powered vehicle, second information regarding a traveling state of the human-powered vehicle, and third information regarding a traveling environment of the human-powered vehicle, and fifth information regarding a decrease amount of the assist level.

According to the control device for the human-powered vehicle of the seventeenth aspect, the assist level can be decreased in accordance with at least one of the first information, the second information, and the third information, and the fifth information, which can further contribute to comfortable traveling of the human-powered vehicle.

In the control device for the human-powered vehicle of an eighteenth aspect according to the seventeenth aspect, the first information includes at least one of information regarding a mean value of the human driving force in a case where a crank of the human-powered vehicle rotates a predetermined number of times and information regarding a maximum value of the human driving force in the case where the crank of the human-powered vehicle rotates the predetermined number of times.

According to the control device for the human-powered vehicle of the eighteenth aspect, the assist level can be decreased in accordance with at least one of the information regarding the mean value of the human driving force and the information regarding the maximum value of the human driving force, which can further contribute to comfortable traveling of the human-powered vehicle.

In the control device for the human-powered vehicle of a nineteenth aspect according to the seventeenth or eighteenth aspect, the second information includes information regarding an inclination of the human-powered vehicle.

According to the control device for the human-powered vehicle of the nineteenth aspect, the assist level can be decreased in accordance with the information regarding the inclination of the human-powered vehicle, which can further contribute to comfortable traveling of the human-powered vehicle.

In the control device for the human-powered vehicle of a twentieth aspect according to any one of the seventeenth to nineteenth aspects, the third information includes information regarding an obliquity of a traveling passage of the human-powered vehicle.

According to the control device for the human-powered vehicle of the twentieth aspect, the assist level can be decreased in accordance with the information regarding the obliquity of the traveling passage of the human-powered vehicle, which can further contribute to comfortable traveling of the human-powered vehicle.

In the control device for the human-powered vehicle of a twenty first aspect according to any one of the fourteenth to twentieth aspects, the electronic controller is configured to change the current assist mode to the changed assist mode through an intermediate assist mode in which the assist level of the intermediate assist mode is lower than the assist level of the current assist mode and higher than the assist level of the changed assist mode in accordance with the level decrease information.

According to the control device for the human-powered vehicle of the twenty first aspect, the assist level can be decreased in a stepwise manner, which can further contribute to comfortable traveling of the human-powered vehicle.

In the control device for the human-powered vehicle of a twenty second aspect according to any one of the fourteenth to twenty first aspects, the electronic controller is configured to change the level decrease information in accordance with an input from at least one of an operation device of an external device and an operation device provided to the human-powered vehicle.

The control device for the human-powered vehicle of the twenty second aspect can improve convenience.

In the control device for the human-powered vehicle of a twenty third aspect according to any one of the first to twenty second aspects, the electronic controller is configured not to change the assist mode in a case where at least one of a steering angle and a roll angle of the human-powered vehicle exceeds a predetermined second threshold.

The control device for the human-powered vehicle of the twenty third aspect can suppress a decrease in the operability of the human-powered vehicle.

The control device for the human-powered vehicle according to the present disclosure can contribute to comfortable traveling of the human-powered vehicle.

### BRIEF DESCRIPTION OF THE DRAWINGS

Referring now to the attached drawings which form a part of this original disclosure, an illustrative embodiment is shown.

FIG. 1 is a side elevational view illustrating a human-powered vehicle including a control device according to a first embodiment.

FIG. 2 is a block diagram illustrating an electrical configuration of the human-powered vehicle including the control device.

FIG. 3 is a diagram showing an example of a plurality of assist modes.

FIG. 4 is a state transition diagram of a drive unit.

FIG. 5 is a diagram showing an example of level increase information for increasing an assist level.

FIG. 6 is a diagram showing an example of level decrease information for decreasing an assist level.

FIG. 7 is a diagram showing an example of a relationship between a change in an assist mode and a time.

FIG. 8 is a flowchart illustrating a control flow executed by the electronic controller shown in FIG. 2 in accordance with the first embodiment.

FIG. 9 is a flowchart illustrating a sub-flow of processing of determining whether or not to change an assist level.

FIG. 10 is a diagram showing a specific example of level increase information in accordance with a second embodiment.

FIG. 11 is a flowchart illustrating a sub-flow of processing of determining whether or not to change an assist level in accordance with the second embodiment.

FIG. 12 is a flowchart illustrating a sub-flow of processing of determining whether or not to change an assist level in accordance with a third embodiment.

FIG. 13 is a flowchart illustrating a control flow according to a fourth embodiment.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

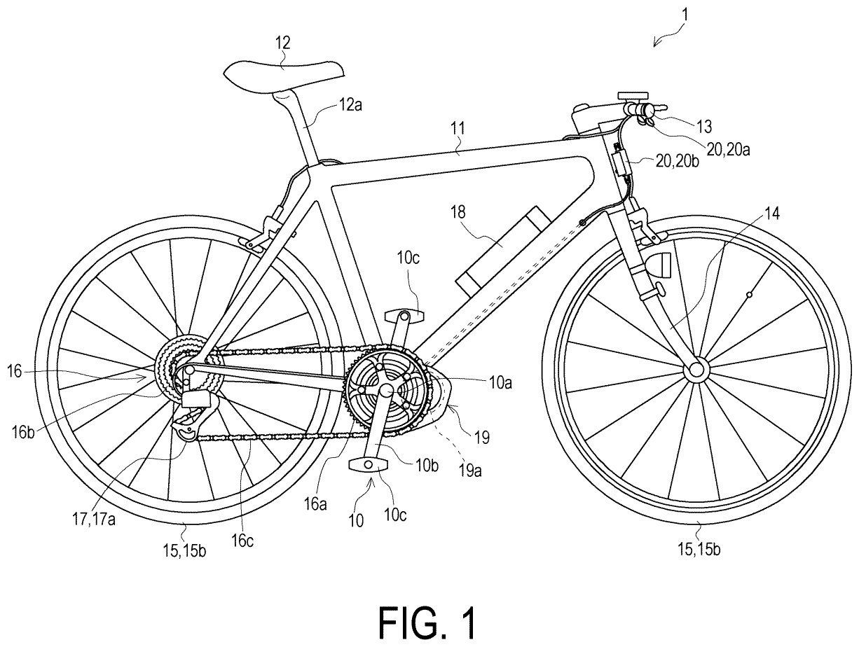

Referring initially to FIG. 1, a human-powered vehicle 1 is illustrated in that is provided with a control device 19b in accordance with a first embodiment.

The human-powered vehicle 1 is a vehicle that includes at least one wheel 15 and can be driven by at least a human driving force. The human-powered vehicle 1 includes various types of bicycles such as a mountain bicycle, a road bicycle, a city bicycle, a cargo bicycle, a handcycle, and a recumbent bicycle, for example. The number of wheels 15 included in the human-powered vehicle 1 is not limited. Examples of the human-powered vehicle 1 include a unicycle and a vehicle having two or more wheels 15. The human-powered vehicle 1 is not limited to a vehicle that can be driven by only a human driving force. The human-powered vehicle 1 includes an E-bike that uses a driving force of an electric motor in addition to the human driving force for propulsion. The E-bike includes an electrically assisted bicycle, which is assisted in propulsion by the electric motor. Hereinafter, embodiments will be described on the assumption that the human-powered vehicle 1 is an electrically assisted bicycle.

The human-powered vehicle 1 includes a crank 10, a frame 11, a seat 12, a steering bar 13, a front fork 14, the wheels 15, a drive mechanism 16, an electric transmission 17, a battery 18, a drive unit 19, and an operation device 20 (e.g., a user operable input device). The crank 10 illustrated in FIG. 1 includes a crankshaft 10a rotatable relative to the frame 11, and a pair of crank arms 10b respectively provided to either end portion of the crankshaft 10a in an axial direction. A pedal 10c is coupled to each crank arm 10b of the pair of crank arms 10b.

The seat 12 is provided to the frame 11 via a seat post 12a. The frame 11 rotatably supports the steering bar 13 and the front fork 14. The steering bar 13 is configured to be grippable by a user. The steering bar 13 is rotated relative to the frame 11, causing the front fork 14 to rotate and changing a traveling direction of the human-powered vehicle 1.

The wheel 15 includes the front wheel 15a and the rear wheel 15b. The front wheel 15a is rotatably mounted on the front fork 14. The rear wheel 15b is rotatably mounted on the frame 11.

The drive mechanism 16 couples the crank 10 and the rear wheel 15b to each other. The drive mechanism 16 includes a first rotation body 16a, a second rotation body 16b, and a driving force transmitting portion 16c. In the present embodiment, the first rotation body 16a includes one front sprocket. The first rotation body 16a can include a plurality of front sprockets.

The first rotation body 16a is configured to rotate with the rotation of the crankshaft 10a. In a case where the crankshaft 10a rotates in a first rotation direction and the human driving force is transmitted to the rear wheel 15b, the human-powered vehicle 1 moves forward. The first rotation body 16a can include a one-way clutch that enables the crankshaft 10a and the first rotation body 16a to rotate integrally in a case where the crankshaft 10a rotates in the first rotation direction, and enables the crankshaft 10a and the first rotation body 16a to rotate relative to each other in a case where the crankshaft 10a rotates in a second rotation direction opposite to the first rotation direction.

In the present embodiment, the second rotation body 16b includes a plurality of rear sprockets. The second rotation body 16b can include one rear sprocket. The second rotation body 16b is coupled to the rear wheel 15b. The driving force transmitting portion 16c transmits the rotational force of the first rotation body 16a to the second rotation body 16b. The driving force transmitting portion 16c includes, for example, a chain. The first rotation body 16a and the second rotation body 16b can include a pulley, and the driving force transmitting portion 16c can include a belt. The first rotation body 16a and the second rotation body 16b can include a bevel gear, and the driving force transmitting portion 16c can include a shaft.

The electric transmission 17 includes at least one of an external transmission device and an internal transmission device. In the present embodiment, the electric transmission 17 includes the external transmission device. In a case where the electric transmission 17 includes the external transmission device, the transmission gear ratio is calculated by, for example, dividing the number of teeth of the front sprocket with which the driving force transmitting portion 16c is engaged by the number of teeth of the rear sprocket with which the driving force transmitting portion 16c is engaged. The external transmission device includes at least one of a front derailleur and a rear derailleur 17a. In the present embodiment, the external transmission device includes the rear derailleur 17a.

The battery 18 includes, for example, at least one of a non-rechargeable battery and a rechargeable battery. The rechargeable battery is configured to be rechargeable with power from an external power supply. The battery 18 is provided to the frame 11.

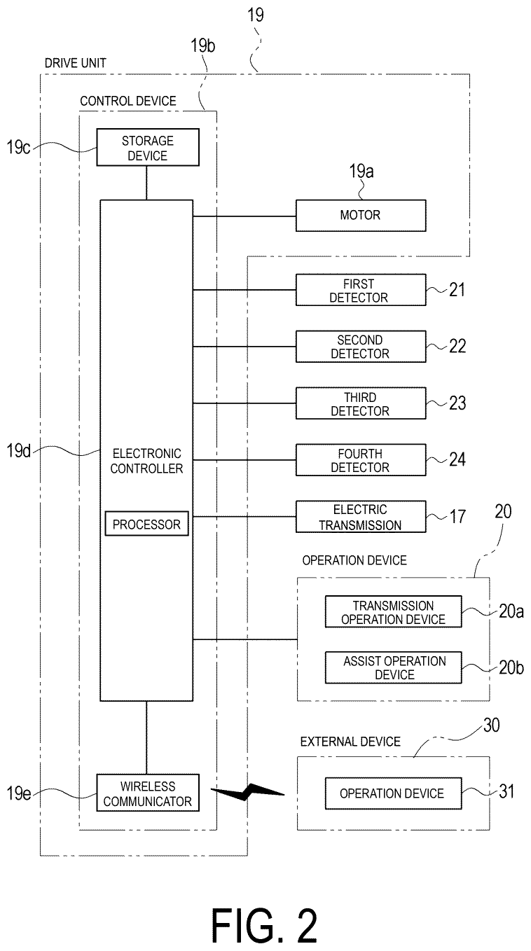

The drive unit 19 is configured to apply an assist force to the human-powered vehicle 1 in accordance with the human driving force input to the pair of crank arms 10b. As illustrated in FIG. 2, the drive unit 19 includes a motor 19a and the control device 19b.

The motor 19a is configured to be driven by power from the battery 18. The motor 19a is configured to transmit a driving force to a power transmission path of the human driving force from each of the pedals 10c to the rear wheel 15b or transmit the driving force to the front wheel 15a. In the present embodiment, the motor 19a is configured to transmit the driving force to the power transmission path of the human driving force. The motor 19a can be configured to transmit the driving force to the power transmission path via a reduction gear.

The control device 19b includes an electronic controller 19d configured to control the motor 19a that applies an assist force to the human-powered vehicle 1 in one assist mode of a plurality of assist modes M having assist levels different from one another. Each assist level includes information for calculating the assist force based on the human driving force.

Each of the assist level includes, for example, at least one of a maximum ratio of an output of the motor 19a to the human driving force input to the human-powered vehicle 1, a maximum value of the output of the motor 19a, and a response speed of the motor 19a. In the present embodiment, each of the assist levels includes the maximum ratio of the output of the motor 19a to the human driving force input to the human-powered vehicle 1. In this specification, the maximum ratio of the output of the motor 19a to the human driving force is referred to as a maximum output ratio.

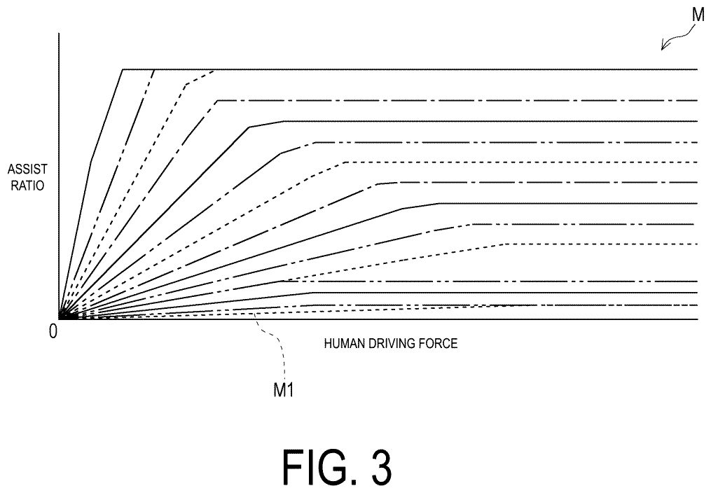

FIG. 3 shows an example of the plurality of assist modes M. Each of the assist ratios shown in FIG. 3 is a ratio of the output of the motor 19a to the human driving force. In FIG. 3, the number of the plurality of assist modes M is 15. The number of the plurality of assist modes M is not limited to 15. In the present embodiment, each of the assist levels further includes an increase ratio of the assist ratio to the human driving force until the assist ratio reaches the maximum assist ratio from zero. The plurality of assist modes M differ from each other in at least one of the maximum output ratio and the increase ratio of the assist ratio to the human driving force. The plurality of assist modes M can further differ from each other in at least one of the maximum value of the output of the motor 19a and the response speed of the motor 19a.

In a case where the motor 19a is controlled in an assist mode having a relatively high maximum output ratio among the plurality of assist modes M, a high assist force is likely to be applied to the human-powered vehicle 1. In a case where the motor 19a is controlled in an assist mode having a relatively high increase ratio of the assist ratio to the human driving force among the plurality of assist modes M, a high assist force is likely to be applied to the human-powered vehicle 1 with increase in the human driving force.

In the present specification, an assist mode having a lowest assist level among the plurality of assist modes M is described as a first mode M1. A low assist level means that a high assist force is less likely to be applied to the human-powered vehicle 1. In the present specification, an assist mode having an N1-th highest assist level among the plurality of assist modes M is described as an N1-th mode. In the present specification, a high assist level means that a high assist force is likely to be applied to the human-powered vehicle 1.

As illustrated in FIG. 2, in the present embodiment, the control device 19b further includes a storage device 19c, an electronic controller 19d and a wireless communicator 19e. The electronic controller 19d is connected to the storage device 19c in a manner allowing retrieval and storage of control program and information to be used in control processing. The electronic controller 19d is connected to the wireless communicator 19e for controlling the wireless communicator 19e to transmit and receive information.

The storage device 19c is any computer storage device or any non-transitory computer-readable medium with the sole exception of a transitory, propagating signal. The storage device 19c stores a control program and information to be used in control processing. The storage device 19c includes, for example, at least one of a non-volatile memory and a volatile memory. The nonvolatile memory includes, for example, at least one of a hard drive, a read-only memory (ROM), an erasable programmable read-only memory (EPROM), an electrically erasable programmable read-only memory (EEPROM), and a flash drive. The volatile memory includes, for example, a random access memory (RAM).

The wireless communicator 19e is configured to perform wireless communication as described below. The term “communicator” as used herein refers to a device or devices, and does not include a human being.

The electronic controller 19d is formed of one or more semiconductor chips that are mounted on a circuit board. Thus, the terms “electronic controller” and “controller” as used herein refers to hardware that executes a software program, and does not include a human being. The electronic controller 19d is configured to perform control related to the drive unit 19. The electronic controller 19d includes an arithmetic processing device that executes a control program determined in advance. The arithmetic processing device includes, for example, a central processing unit (CPU) or a micro processing unit (MPU) having a one or more processors. The electronic controller 19d can include one or a plurality of microcomputers having a one or more processors. The electronic controller 19d further includes an inverter circuit connected to the motor 19a.

The electronic controller 19d has a function of measuring a time. The electronic controller 19d can measure a time using, for example, a CPU or MPU or can include a timer or a timepiece. As shown in FIG. 2, the human-powered vehicle 1 further includes one or more detectors for detecting one or more traveling conditions of the human-powered vehicle 10. The term “detector” as used herein refers to a hardware device or instrument designed to detect the presence or absence of a particular event, object, substance, or a change in its environment, and to emit a signal in response. The term “detector” as used herein do not include a human being. The electronic controller 19d is configured to communicate with a first detector 21, a second detector 22, a third detector 23, and a fourth detector 24 through an electric cable or a wireless communication device.

The first detector 21 is configured to detect information regarding the human driving force input to the human-powered vehicle 1. The information regarding the human driving force is information that changes in accordance with the human driving force input to the human-powered vehicle 1. The first detector 21 includes, for example, a torque sensor. The torque sensor is configured to detect information regarding a torque input to the pair of crank arms 10b. For example, the torque sensor is provided to at least one of the transmission path for the driving force from the pedals 10c to the first rotation body 16a and the drive unit 19. The torque sensor includes, for example, a strain sensor. The torque sensor can include a magnetostrictive sensor, an optical sensor, and a pressure sensor.

In a case where the first detector 21 includes the torque sensor, the first detector 21 outputs, to the electronic controller 19d, a signal corresponding to a torque input to the pair of crank arms 10b. The electronic controller 19d can detect the human driving force based on the signal output from the first detector 21.

The second detector 22 is configured to detect information regarding the traveling state of the human-powered vehicle 1. The information regarding the traveling state is information that changes in accordance with the traveling state of the human-powered vehicle 1. The information regarding the traveling state of the human-powered vehicle 1 includes, for example, information regarding the inclination state of the human-powered vehicle 1. The information regarding the inclination state of the human-powered vehicle 1 is information that changes in accordance with the inclination of the frame 11 of the human-powered vehicle 1. The information regarding the inclination state of the human-powered vehicle 1 includes, for example, information regarding the pitch angle of the human-powered vehicle 1.

The second detector 22 includes, for example, a motion sensor. The motion sensor is configured to detect information regarding vertical acceleration in a state where the human-powered vehicle 1 is disposed on a horizontal plane. The motion sensor can include a three-axis acceleration sensor. The motion sensor can include a six-axis gyro sensor. In a case where the second detector 22 includes the motion sensor, the second detector 22 outputs, to the electronic controller 19d, a signal corresponding to vertical acceleration in a state where the human-powered vehicle 1 is disposed on a horizontal plane. The electronic controller 19d can detect the pitch angle of the human-powered vehicle 1 based on the signal output from the second detector 22.

The second detector 22 can be configured to further detect information regarding the roll angle of the human-powered vehicle 1 as the information regarding the inclination state of the human-powered vehicle 1. In a case where the second detector 22 detects the information regarding the roll angle, the second detector 22 can include a motion sensor that detects information regarding acceleration in the left-right direction in a state where the human-powered vehicle 1 is disposed on a horizontal plane. Since the steering angle of the human-powered vehicle 1 is correlated with the roll angle of the human-powered vehicle 1, the second detector 22 can be configured to further detect information regarding the steering angle of the human-powered vehicle 1 as the information regarding the inclination state of the human-powered vehicle 1. In a case where the second detector 22 detects the information regarding the steering angle, the second detector 22 can include, for example, a rotation sensor that detects at least one of the angle of the steering bar 13 with respect to the frame 11 and the angle of the front fork 14 with respect to the frame 11. The electronic controller 19d can detect at least one of the roll angle and the steering angle based on a signal output from the second detector 22.

The information regarding the traveling state of the human-powered vehicle 1 can include information different from the information regarding the inclination state of the human-powered vehicle 1. The information regarding the traveling state of the human-powered vehicle 1 can include, for example, information regarding a cadence.

The third detector 23 is configured to detect information regarding the traveling environment of the human-powered vehicle 1. The information regarding the traveling environment is information that changes in accordance with the traveling environment of the human-powered vehicle 1. The information regarding the traveling environment of the human-powered vehicle 1 includes, for example, information regarding the obliquity of the traveling passage of the human-powered vehicle 1. For example, the third detector 23 is configured to detect the obliquity of the traveling passage based on the information regarding the pitch angle of the human-powered vehicle 1 detected by the second detector 22. The third detector 23 outputs, to the electronic controller 19d, a signal corresponding to the obliquity of the traveling passage. The electronic controller 19d can detect the obliquity of the traveling passage based on the signal output from the third detector 23.

The third detector 23 can detect the information regarding the obliquity of the traveling passage based on information different from the pitch angle. For example, the third detector 23 can detect the information regarding the obliquity of the traveling passage based on the current position of the human-powered vehicle 1. In a case where the third detector 23 detects the information regarding the obliquity of the traveling passage based on the current position of the human-powered vehicle 1, the third detector 23 can include, for example, a GPS reception unit (also called a GPS receiver) provided to the human-powered vehicle 1. The GPS reception unit is configured to output, a signal to the electronic controller 19d regarding the current position of the human-powered vehicle 1. The electronic controller 19d can detect the obliquity of the traveling passage of the human-powered vehicle 1 based on the signal output from the GPS reception unit and slope information included in map information stored in the storage device 19c in advance.

The information regarding the traveling environment of the human-powered vehicle 1 can include information different from the information regarding the obliquity of the traveling passage of the human-powered vehicle 1. The information regarding the traveling environment of the human-powered vehicle 1 can include, for example, information regarding the type of traveling passage. Examples of the type of traveling passage can include an on-road type road and an off-road type.

The fourth detector 24 is configured to detect information regarding the rotation of the wheels 15. The information regarding the rotation of the wheels 15 is information that changes in accordance with the rotation of the wheels 15. The fourth detector 24 includes, for example, a wheel rotation sensor. The wheel rotation sensor is configured to, for example, detect a magnetic field of a magnet mounted on the wheels 15. In a case where the fourth detector 24 includes the wheel rotation sensor, the fourth detector 24 outputs, to the electronic controller 19d, a signal regarding the magnetic field of the magnet. The electronic controller 19d can detect the vehicle speed of the human-powered vehicle 1 based on the signal output from the wheel rotation sensor. The fourth detector 24 is not particularly limited as long as the fourth detector 24 is configured to detect the information regarding the rotation of the wheels 15.

The electronic controller 19d is configured to communicate with the operation device 20 and the electric transmission 17 through an electric cable or a wireless communication device. The operation device 20 is provided in the human-powered vehicle 1. The operation device 20 is configured to be operable by a user using a hand or a finger. The operation device 20 can also be referred to as a user operable input device. The operation device 20 can include, for example, one or more of a button, a switch, a lever, a dial and/or a touch screen. In the present embodiment, the operation device 20 includes a transmission operation device 20a and an assist operation device 20b. The transmission operation device 20a can also be referred to as a transmission user operable input device, and the assist operation device 20b can also be referred to as an assist user operable input device.

The transmission operation device 20a is configured to perform a transmission operation for changing the transmission gear ratio of the human-powered vehicle 1. The transmission operation device 20a is provided to the steering bar 13, for example. In a case where the transmission operation device 20a is operated, a signal regarding the transmission operation is output to the electronic controller 19d. The electronic controller 19d is configured to detect the transmission operation based on the signal regarding the transmission operation. The electronic controller 19d can control the electric transmission 17 so as to change the transmission gear ratio by outputting a signal to the electric transmission 17 in accordance with the transmission operation. For example, the electronic controller 19d can control the rear derailleur 17a so as to shift the driving force transmitting portion 16c between the plurality of rear sprockets.

The assist operation device 20b is configured to perform an assist operation for changing the assist mode through an operation of the user. The assist operation device 20b includes, for example, at least one assist switch. In a case where the at least one assist switch is operated, a signal regarding the assist operation is output to the electronic controller 19d. The electronic controller 19d is configured to detect the assist operation based on the signal regarding the assist operation. The at least one assist switch includes, for example, two assist switches. The two assist switches include, for example, a first switch for increasing the assist level and a second switch for decreasing the assist level.

The user can select one assist mode from among the plurality of assist modes M by operating the at least one assist switch. The electronic controller 19d can control the motor 19a in accordance with the one assist mode selected by the user. In the present specification, the one assist mode selected by the user is described as a user-designated assist mode M0. In the present specification, the assist level of the user-designated assist mode M0 is described as a user-designated assist level L0.

The wireless communicator 19e is configured to wirelessly communicate with a device different from the control device 19b. The wireless communicator 19e can be configured to perform communication in accordance with an existing communication standard such as Bluetooth (trade name) or ANT+ (trade name), or can be configured to perform wireless communication in accordance with a unique communication standard. The wireless communicator 19e includes, for example, a wireless communication circuit and an antenna. The electronic controller 19d is configured to wirelessly communicate with an external device 30 via the wireless communicator 19e.

The external device 30 includes, for example, a device that can change the setting of the human-powered vehicle 1 from the outside. The external device 30 includes an operation device 31 configured to be operable by a user using a hand or a finger. The operation device 31 can also be referred to as a user operable input device. The operation device 31 can include, for example, a button, a switch, a lever, a dial and/or a touch screen. The external device 30 is configured of, for example, a smartphone in which a predetermined application is installed. For example, in a case where the predetermined application is activated and a predetermined operation is performed, the external device 30 outputs a signal to the wireless communicator 19e. The electronic controller 19d is configured to detect the user operation on the external device 30 based on the signal from the external device 30 in a case where the signal is received from the external device 30 through the wireless communicator 19e. The electronic controller 19d can change the setting of the human-powered vehicle 1 in accordance with the detected user operation.

The external device 30 is not limited to a smartphone as long as the external device 30 is a device capable of wirelessly communicating with the wireless communicator 19e. The external device 30 can be, for example, a tablet-type computer in which the predetermined application is installed.

The electronic controller 19d is configured to change the current assist mode to a changed assist mode different from the current assist mode depending on the current assist mode in a case where the traveling condition regarding the traveling state of the human-powered vehicle 1 is satisfied. The electronic controller 19d can finely control an assist force based on the current assist mode by changing the assist mode depending on the current assist mode. This can improve comfort in traveling of the human-powered vehicle 1.

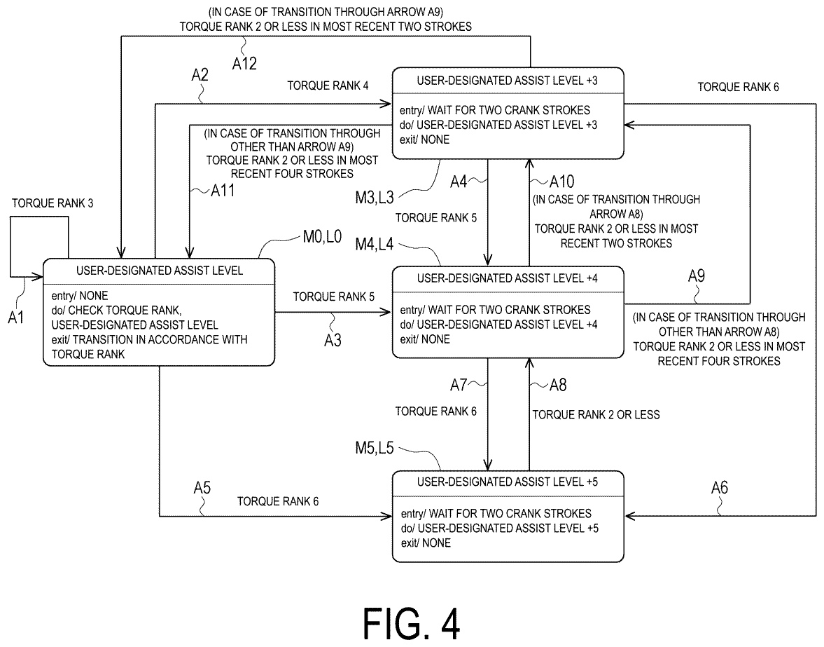

FIG. 4 illustrates an example of a state transition diagram of the drive unit 19 in a case where the assist mode is changed by the electronic controller 19d. In a case where the traveling condition is not satisfied, the electronic controller 19d controls the motor 19a in the user-designated assist mode M0. In a case where the traveling condition is satisfied in the user-designated assist mode M0, the electronic controller 19d changes the assist mode to any of a user-designated assist level +3, a user-designated assist level +4, and a user-designated assist level +5.

In the case of the user-designated assist level +3 illustrated in FIG. 4, the assist mode has an assist level three levels higher than that of the user-designated assist mode M0 among the plurality of assist modes M. In the present specification, the assist mode having an assist level three levels higher than that of the user-designated assist mode M0 is described as a third increase mode M3. In the present specification, the assist level of the third increase mode M3 is described as a third increase level L3.

In the case of the user-designated assist level +4 illustrated in FIG. 4, the assist mode has an assist level four levels higher than that of the user-designated assist mode M0 among the plurality of assist modes M. In the present specification, the assist mode having an assist level four levels higher than that of the user-designated assist mode M0 is described as a fourth increase mode M4. In the present specification, the assist level of the fourth increase mode M4 is described as a fourth increase level L4.

In the case of the user-designated assist level +5 illustrated in FIG. 4, the assist mode has an assist level five levels higher than that of the user-designated assist mode M0 among the plurality of assist modes M. In the present specification, the assist mode having an assist level five levels higher than that of the user-designated assist mode M0 is described as a fifth increase mode M5. In the present specification, the assist level of the fifth increase mode M5 is described as a fifth increase level L5.

A method of determining an assist mode after the change will be described with reference to FIGS. 4 to 7. The electronic controller 19d is configured to change the current assist mode to a changed assist mode in accordance with information regarding the current assist mode and mode determination information T. The information regarding the current assist mode includes information with which the assist mode can be identified. In the assist mode, the motor 19a is currently controlled among the plurality of assist modes M. In the present embodiment, the information regarding the current assist mode includes information with which the user-designated assist mode M0 can be identified, the third increase mode M3, the fourth increase mode M4, and the fifth increase mode M5.

The mode determination information T includes information for determining which assist mode of the plurality of assist modes M is set as the assist mode after the change. In the present embodiment, the mode determination information T includes level increase information T1 for determining the assist mode after the change such that the assist level increases. The level increase information T1 includes at least one of first information regarding the human driving force input to the human-powered vehicle 1, second information regarding the traveling state of the human-powered vehicle 1, and third information regarding the traveling environment of the human-powered vehicle 1, and fourth information regarding the increase amount of the assist level.

The increase amount of the assist level is information with which it is possible to identify how much the assist level is increased from the assist level of the current assist mode. In the present embodiment, the increase amount of the assist level is a value indicating how many levels the assist level is increased with reference to the user-designated assist level L0 in the plurality of assist modes M.

The first information is information that changes in accordance with the human driving force. The first information includes at least one of information regarding the mean value of the human driving force in a case where the crank 10 of the human-powered vehicle 1 rotates a predetermined number of times, and information regarding the maximum value of the human driving force in the case where the crank 10 of the human-powered vehicle 1 rotates the predetermined number of times. The predetermined number of times can be, for example, in a range of 1 to 5 and is not particularly limited. For example, the first information can include at least one of information regarding the mean value of the human driving force in a case where the crank 10 rotates twice and information regarding the maximum value of the human driving force in the case where the crank 10 rotates twice. The electronic controller 19d can acquire the first information by detecting the human driving force based on a signal from the first detector 21.

The second information is information that changes in accordance with the traveling state of the human-powered vehicle 1. The second information includes information regarding the inclination of the human-powered vehicle 1. The electronic controller 19d can acquire the second information by detecting the inclination state of the human-powered vehicle 1 based on a signal from the second detector 22. For example, the electronic controller 19d can acquire the pitch angle of the human-powered vehicle 1 as the second information. The third information is information that changes in accordance with the traveling environment of the human-powered vehicle 1. The third information includes information regarding the obliquity of the traveling passage of the human-powered vehicle 1. The electronic controller 19d can acquire the obliquity of the traveling passage based on a signal from the third detector 23. The fourth information includes information with which the increase amount of the assist level can be identified.

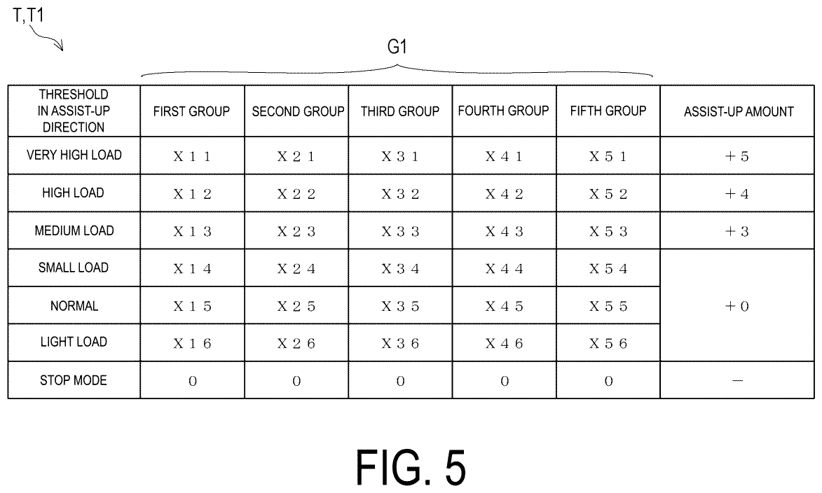

In the present embodiment, the level increase information T1 includes the first information regarding the human driving force and the fourth information regarding the increase amount of the assist level. FIG. 5 shows an example of the level increase information T1. The level increase information T1 shown in FIG. 5 is a table for determining the increase amount of the assist level based on the human driving force.

An assist-up direction shown in FIG. 5 means that the assist level increases with reference to the current assist mode. Thresholds in the assist-up direction shown in FIG. 5 are thresholds of the human driving force for determining the increase amount of the assist level. In the present embodiment, the thresholds in the assist-up direction are defined in a stepwise manner in accordance with the load on the user. As the thresholds in the assist-up direction, seven thresholds are separately defined, i.e., a threshold for a very high load, a threshold for a high load, a threshold for a medium load, a threshold for a small load, a normal threshold, a threshold for a light load, and a threshold for a stop mode. The stop mode is a state in which the human-powered vehicle 1 stops.

The threshold for the very high load is greater than the threshold for the high load. The threshold for the high load is greater than the threshold for the medium load. The threshold for the medium load is greater than the threshold for the small load. The threshold for the small load is greater than the normal threshold. The normal threshold is greater than the threshold for the light load. The threshold for the stop mode can be omitted.

The thresholds in the assist-up direction are defined for each of a plurality of groups G1. In the present embodiment, the thresholds in the assist-up direction are defined for each of a first group, a second group, a third group, a fourth group, and a fifth group. In the present embodiment, the thresholds in the assist-up direction increase in a stepwise manner from the first group toward the fifth group, except for the threshold for the light load.

For example, a threshold X11 for the very high load of the first group can be a value within a range from 50 Nm to 130 Nm. For example, a threshold X12 for the high load of the first group can be a value within a range from 30 Nm to 80 Nm. For example, a threshold X13 for the medium load of the first group can be a value within a range from 25 Nm to 70 Nm. For example, a threshold X14 for the small load of the first group can be a value within a range from 20 Nm to 50 Nm. For example, a normal threshold X15 of the first group can be a value within a range from 5 Nm to 30 Nm.

The thresholds of the groups other than the first group can be defined with reference to the thresholds of the first group. For example, the thresholds of the groups other than the first group can be defined by adding a first variable to the thresholds of the first group. A value of the first variable increases from the first group toward the fifth group.

The first variable can be defined in a stepwise manner in accordance with the load on the user. For example, the first variable can be defined such that the value increases as the load on the user increases. For example, the first variable added to the threshold for the very high load can be greater than the first variable added to the threshold for the high load. The first variable added to the threshold for the high load can be greater than the first variable added to the threshold for the medium load. The first variable added to the threshold for the medium load can be greater than the first variable added to the threshold for the small load. The first variable added to the threshold for the small load can be greater than the first variable added to the normal threshold. A method of defining the thresholds in the assist-up direction for each of the plurality of groups G is not limited to that of the present embodiment. For example, the first variable does not need to be defined in a stepwise manner in accordance with the load on the user.

In the present embodiment, each of the thresholds of an N1-th group of the first group to the fifth group is set to a numerical value for enabling suitable control of the assist level in a case where the human-powered vehicle 1 travels uphill. FIG. 5 illustrates an example of the thresholds.

The thresholds X11, X12, X13, X14, and X15 shown in the first group of FIG. 5 satisfy the relationship of X11>X12>X13>X14>X15. Thresholds X21, X22, X23, X24, and X25 shown in the second group of FIG. 5 satisfy the relationship of X21>X22>X23>X24>X25. Thresholds X31, X32, X33, X34, and X35 shown in the third group of FIG. 5 satisfy the relationship of X31>X32>X33>X34>X35. Thresholds X41, X42, X43, X44, and X45 shown in the fourth group of FIG. 5 satisfy the relationship of X41>X42>X43>X44>X45. Thresholds X51, X52, X53, X54, and X55 shown in the fifth group of FIG. 5 satisfy the relationship of X51>X52>X53>X54>X55.

The thresholds X11, X21, X31, X41, and X51 shown in the very high load of FIG. 5 satisfy the relationship of X11<X21<X31<X41<X51. The thresholds X12, X22, X32, X42, and X52 shown in the high load of FIG. 5 satisfy the relationship of X12<X22<X32<X42<X52. The thresholds X13, X23, X33, X43, and X53 shown in the medium load of FIG. 5 satisfy the relationship of X13<X23<X33<X43<X53. The thresholds X14, X24, X34, X44, and X54 shown in the small load of FIG. 5 satisfy the relationship of X14<X24<X34<X44<X54. The thresholds X15, X25, X35, X45, and X55 shown in the normal of FIG. 5 satisfy the relationship of X15<X25<X35<X45<X55.

For example, the thresholds shown in FIG. 5 further satisfy the following relationships (1), (2), (3), (4), and (5). In the relationships (1), (2), (3), (4), and (5), A1, A2, A3, A4, and A5 are numerical values and satisfy the relationship of A1<A2<A3<A4<A5.

$$X 12 - X 11 = X 13 - X 12 = X 14 - X 13 = X 15 - X 14 = A 1 \qquad ( 1 )$$

$$X 22 - X 21 = X 23 - X 22 = X 24 - X 23 = X 25 - X 24 = A 2 \qquad ( 2 )$$

$$X 32 - X 31 = X 33 - X 32 = X 34 - X 33 = X 35 - X 34 = A 3 \qquad ( 3 )$$

$$X 42 - X 41 = X 43 - X 42 = X 44 - X 43 = X 45 - X 44 = A 4 \qquad ( 4 )$$

$$X 52 - X 51 = X 53 - X 52 = X 54 - X 53 = X 55 - X 54 = A 5 \qquad ( 5 )$$

For example, the thresholds shown in FIG. 5 further satisfy the following relationships (6), (7), (8), (9), and (10). In the relationships (6), (7), (8), (9), and (10), B1, B2, B3, B4, and B5 are numerical values and satisfy the relationship of B1>B2>B3>B4>B5.

$$X 21 - X 11 = X 31 - X 21 = X 41 - X 31 = X 51 - X 41 = B 1 \qquad ( 6 )$$

$$X 22 - X 12 = X 32 - X 22 = X 42 - X 32 = X 52 - X 42 = B 2 \qquad ( 7 )$$

$$X 23 - X 13 = X 33 - X 23 = X 43 - X 33 = X 53 - X 43 = B 3 \qquad ( 8 )$$

$$X 24 - X 14 = X 34 - X 24 = X 44 - X 34 = X 54 - X 44 = B 4 \qquad ( 9 )$$

$$X 25 - X 15 = X 35 - X 25 = X 45 - X 35 = X 55 - X 45 = B 5 \qquad ( 10 )$$

An assist-up amount shown in FIG. 5 is the increase amount of the assist level. The assist-up amount is defined in a stepwise manner in accordance with each of the threshold for the very high load, the threshold for the high load, the threshold for the medium load, the threshold for the small load, the normal threshold, the threshold for the light load, and the threshold for the stop mode. The assist-up amount of +0 shown in FIG. 5 means that the increase amount of the assist level is zero. The assist-up amount of +0 is associated with the threshold for the light load, the threshold for the normal threshold, and the threshold for the small load.

The assist-up amount of +3 shown in FIG. 5 means that the increase amount of the assist level is 3. The assist-up amount of +3 is associated with the threshold for the medium load. The assist-up amount of +4 means that the increase amount of the assist level is 4. The assist-up amount of +4 is associated with the threshold for the high load. The assist-up amount of +5 means that the increase amount of the assist level is 5. The assist-up amount of +5 is associated with the threshold for the very high load.

The increase amount of the assist level is not limited to the assist-up amount shown in FIG. 5. The increase amounts of the assist levels for the threshold for the light load, the normal threshold, and the threshold for the small load do not need to be set to the same value. The increase amounts can be set to different values for the thresholds in the assist-up direction from the threshold for the light load, which has a smallest value, to the threshold for the very high load, which has a largest value. The increase amount of the assist level can increase step by step as the threshold increases step by step from the threshold for the light load. For example, the increase amount of the assist level can increase one by one as the threshold increases step by step from the threshold for the light load.

The electronic controller 19d determines the increase amount of the assist level in accordance with the human driving force by comparing at least one of the thresholds of one group of the plurality of groups G1 with the human driving force. In the present embodiment, the electronic controller 19d determines the increase amount of the assist level in accordance with the human driving force by comparing the threshold for the very high load, the threshold for the high load, and the threshold for the medium load of one group with the human driving force.

For example, in a case where the human driving force is equal to or greater than X31 Nm, and each threshold of the third group is compared with the human driving force, the electronic controller 19d determines the increase amount of the assist level to be 5. In a case where the electronic controller 19d determines the increase amount of the assist level to be 5, the electronic controller 19d determines the fifth increase mode M5 to be the assist mode after the change.

The mode determination information T further includes level decrease information T2 for determining the assist mode after the change such that the assist level decreases. The level decrease information T2 includes at least one of first information regarding the human driving force input to the human-powered vehicle 1, second information regarding the traveling state of the human-powered vehicle 1, and third information regarding the traveling environment of the human-powered vehicle 1, and fifth information regarding the decrease amount of the assist level.

The decrease amount of the assist level is information with which it is possible to identify how much the assist level is decreased from the assist level of the current assist mode. In the present embodiment, the decrease amount of the assist level is a value indicating how many levels the assist level is decreased with reference to the current assist level in the plurality of assist modes M.

The first information is information that changes in accordance with the human driving force. The first information includes at least one of information regarding the mean value of the human driving force in a case where the crank 10 of the human-powered vehicle 1 rotates a predetermined number of times, and information regarding the maximum value of the human driving force in the case where the crank 10 of the human-powered vehicle 1 rotates the predetermined number of times. The first information in the level decrease information T2 can be identical to the first information in the level increase information T1. The first information in the level decrease information T2 can be different from the first information in the level increase information T1. For example, the predetermined number of times can be different between the level increase information T1 and the level decrease information T2.

The second information is information that changes in accordance with the traveling state of the human-powered vehicle 1. The second information includes information regarding the inclination of the human-powered vehicle 1. The second information in the level decrease information T2 can be identical to the second information in the level increase information T1. The second information in the level decrease information T2 can be different from the second information in the level increase information T1.

The third information is information that changes in accordance with the traveling environment of the human-powered vehicle 1. The third information includes information regarding the obliquity of the traveling passage of the human-powered vehicle 1. The third information in the level decrease information T2 can be identical to the third information in the level increase information T1. The third information in the level decrease information T2 can be different from the third information in the level increase information T1. The fifth information includes information with which it is possible to identify the decrease amount of the assist level.

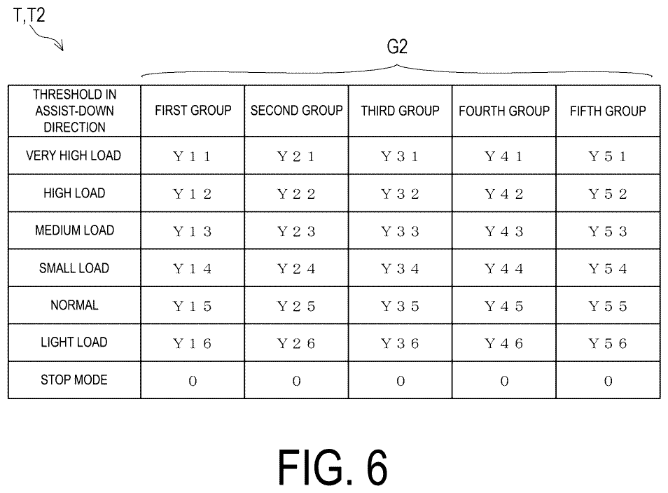

In the present embodiment, the level decrease information T2 includes the first information regarding the human driving force and the fifth information regarding the decrease amount of the assist level. FIG. 6 shows an example of the level decrease information T2. The level decrease information T2 shown in FIG. 6 is a table for determining the decrease amount of the assist level based on the human driving force.

An assist-down direction shown in FIG. 6 means that the assist level decreases with reference to the current assist mode. Thresholds in the assist-down direction shown in FIG. 6 are thresholds of the human driving force for determining the decrease amount of the assist level. In the present embodiment, in a manner similar to the thresholds in the assist-up direction of the level increase information T1, seven thresholds are separately defined as the thresholds in the assist-down direction, i.e., a threshold for a very high load, a threshold for a high load, a threshold for a medium load, a threshold for a small load, a normal threshold, a threshold for a light load, and a threshold for a stop mode. In a manner similar to the thresholds in the assist-up direction of the level increase information T1, the thresholds in the assist-down direction are defined for each of a plurality of groups G2. The number of the plurality of groups G2 is equal to the number of the plurality of groups G1 of the level increase information T1.

A first group of the level decrease information T2 corresponds to the first group of the level increase information T1. A second group of the level decrease information T2 corresponds to the second group of the level increase information T1. A third group of the level decrease information T2 corresponds to the third group of the level increase information T1. A fourth group of the level decrease information T2 corresponds to the fourth group of the level increase information T1. A fifth group of the level decrease information T2 corresponds to the fifth group of the level increase information T1. A method of defining the thresholds in the assist-down direction for each of the plurality of groups G2 can be, for example, the same as the method of defining the thresholds in the assist-up direction of the level increase information T1.

Thresholds Y11, Y12, Y13, Y14, and Y15 shown in the first group of FIG. 6 satisfy the relationship of Y11>Y12>Y13>Y14>Y15. Thresholds Y21, Y22, Y23, Y24, and Y25 shown in the second group of FIG. 6 satisfy the relationship of Y21>Y22>Y23>Y24>Y25. Thresholds Y31, Y32, Y33, Y34, and Y35 shown in the third group of FIG. 6 satisfy the relationship of Y31>Y32>Y33>Y34>Y35. Thresholds Y41, Y42, Y43, Y44, and Y45 shown in the fourth group of FIG. 6 satisfy the relationship of Y41>Y42>Y43>Y44>Y45. Thresholds Y51, Y52, Y53, Y54, and Y55 shown in the fifth group of FIG. 6 satisfy the relationship of Y51>Y52>Y53>Y54>Y55.

The thresholds Y11, Y21, Y31, Y41, and Y51 shown in the very high load of FIG. 6 satisfy the relationship of Y11<Y21<Y31<Y41<Y51. The thresholds Y12, Y22, Y32, Y42, and Y52 shown in the high load of FIG. 6 satisfy the relationship of Y12<Y22<Y32<Y42<Y52. The thresholds Y13, Y23, Y33, Y43, and Y53 shown in the medium load of FIG. 6 satisfy the relationship of Y13<Y23<Y33<Y43<Y53. The thresholds Y14, Y24, Y34, Y44, and Y54 shown in the small load of FIG. 6 satisfy the relationship of Y14<Y24<Y34<Y44<Y54. The thresholds Y15, Y25, Y35, Y45, and Y55 shown in the normal of FIG. 6 satisfy the relationship of Y15<Y25<Y35<Y45<Y55.

For example, the thresholds shown in FIGS. 5 and 6 further satisfy the following relationships (11), (12), (13), (14), and (15).

X11>Y11,X12>Y12,X13>Y13,X14>Y14,X15>Y15 (11)

X21>Y21,X22>Y22,X23>Y23,X24>Y24,X25>Y25 (12)

X31>Y31,X32>Y32,X33>Y33,X34>Y34,X35>Y35 (13)

X41>Y41,X42>Y42,X43>Y43,X44>Y44,X45>Y45 (14)

X51>Y51,X52>Y52,X53>Y53,X54>Y54,X55>Y55 (15)

The electronic controller 19d determines the decrease amount of the assist level in accordance with the human driving force by comparing at least one threshold of one group of the plurality of groups G2 with the human driving force. In the present embodiment, the electronic controller 19d determines the decrease amount of the assist level so as to return the assist level to the user-designated assist level L0 in a case where the human driving force is equal to or less than the normal threshold of one group.

In a case where the decrease amount of the assist level is determined, the electronic controller 19d changes the current assist mode to a changed assist mode having a lower assist level than the current assist mode in accordance with the determined decrease amount of the assist level. For example, in a case where the human driving force in the fifth increase mode M5 is equal to or less than 10 Nm and the human driving force is compared with the normal threshold of the third group, the electronic controller 19d determines the decrease amount of the assist level to be 5. In a case where the decrease amount of the assist level is determined to be 5, the electronic controller 19d changes the assist mode from the fifth increase mode M5 to the user-designated assist mode M0 having an assist level five levels lower than that of the fifth increase mode M5 in accordance with the determined decrease amount of the assist level of 5.

Control for decreasing the assist mode by the electronic controller 19d is not particularly limited. In the present embodiment, the electronic controller 19d changes the assist mode so as to decrease the assist level in a stepwise manner one by one, instead of directly changing the assist mode from the fifth increase mode M5 to the user-designated assist mode M0. In a case where the decrease amount of the assist level is determined, the electronic controller 19d changes the current assist mode to a changed assist mode having an assist level one level lower than that of the current assist mode regardless of the determined decrease amount of the assist level. For example, in a case where the decrease amount of the assist level is determined to be 5 in the fifth increase mode M5, the electronic controller 19d changes the assist mode from the fifth increase mode M5 to the fourth increase mode M4 having an assist level one level lower than that of the fifth increase mode M5, instead of the user-designated assist mode M0 having an assist level five levels lower than that of the fifth increase mode M5. In a case where the electronic controller 19d changes the assist mode so as to decrease the assist level in a stepwise manner one by one, the electronic controller 19d can determine the decrease amount of the assist level to be 1 regardless of the magnitude of the human driving force.

The electronic controller 19d is configured to change the level increase information T1 in accordance with an input from at least one of the operation device 31 of the external device 30 and the operation device 20 provided in the human-powered vehicle 1. The electronic controller 19d is configured to change the level decrease information T2 in accordance with an input from at least one of the operation device 31 of the external device 30 and the operation device 31 provided in the human-powered vehicle 1.

In the present embodiment, the electronic controller 19d changes the level increase information T1 and the level decrease information T2 by changing one group to be compared with the human driving force among the first group to the fifth group in accordance with an input from at least one of the operation device 31 of the external device 30 and the operation device 20 provided in the human-powered vehicle 1. The user can change the level increase information T1 and the level decrease information T2 by operating at least one of the operation device 31 of the external device 30 and the operation device 20 provided in the human-powered vehicle 1, which improves convenience.

A method of changing the level increase information T1 and the level decrease information T2 is not limited to that of the present embodiment. For example, the electronic controller 19d can change the level increase information T1 and the level decrease information T2 by changing the thresholds defined in the level increase information T1 and the level decrease information T2 in accordance with an input from at least one of the operation device 31 of the external device 30 and the operation device 20 provided in the human-powered vehicle 1.

The traveling condition for changing the assist mode will be described. The traveling condition includes a first traveling condition satisfied in a case where at least one of a condition regarding the human driving force input to the human-powered vehicle 1, a condition regarding the traveling state of the human-powered vehicle 1, and a condition regarding the traveling environment of the human-powered vehicle 1 is satisfied. The first traveling condition is a condition for increasing the assist level by changing the assist mode. The first traveling condition is satisfied in a case where the load on the user is relatively high during the traveling of the human-powered vehicle 1.

The condition regarding the human driving force is satisfied, for example, in a case where the human driving force is equal to or greater than a predetermined threshold. The predetermined threshold can be determined based on the level increase information T1, for example. The predetermined threshold can change in accordance with the current assist mode.

The condition regarding the human driving force is satisfied, for example, in a case where, in the user-designated assist mode M0, the human driving force is equal to or greater than the threshold for the medium load of one group selected by the user from among the first group to the fifth group of the level increase information T1. In the present specification, the one group selected by the user is described as a selected group. The selected group is common between the level increase information T1 and the level decrease information T2.

The condition regarding the human driving force is satisfied, for example, in a case where, in the third increase mode M3, the human driving force is equal to or greater than the threshold for the high load of the selected group of the level increase information T1. The condition regarding the human driving force is satisfied, for example, in a case where, in the fourth increase mode M4, the human driving force is equal to or greater than the threshold for the very high load of the selected group of the level increase information T1.

The condition regarding the traveling state of the human-powered vehicle 1 is satisfied, for example, in a case where the pitch angle of the human-powered vehicle 1 is equal to or greater than a predetermined threshold. The predetermined threshold can change in accordance with the current assist mode.

The condition regarding the traveling environment of the human-powered vehicle 1 is satisfied, for example, in a case where the obliquity of the traveling passage of the human-powered vehicle 1 is equal to or greater than a predetermined threshold. The predetermined threshold can change in accordance with the current assist mode.

In the present embodiment, the first traveling condition is satisfied in a case where the condition regarding the human driving force is satisfied. In a case where the first traveling condition is satisfied, the electronic controller 19d changes the current assist mode to a changed assist mode determined in accordance with the level increase information T1.

The traveling condition further includes a second traveling condition different from the first traveling condition. The second traveling condition is a condition for decreasing the assist level by changing the assist level. The second traveling condition is satisfied in a case where the load on the user is relatively light during the traveling of the human-powered vehicle 1. The second traveling condition is satisfied in a case where at least one of a condition regarding the human driving force input to the human-powered vehicle 1, a condition regarding the traveling state of the human-powered vehicle 1, and information regarding the traveling environment of the human-powered vehicle 1 is satisfied.

The condition regarding the human driving force is satisfied, for example, in a case where the human driving force is equal to or less than a predetermined threshold. The predetermined threshold can be defined based on the level decrease information T2, for example. The predetermined threshold can change in accordance with the current assist mode.

The condition regarding the human driving force is satisfied, for example, in a case where, in the third increase mode M3, the fourth increase mode M4, and the fifth increase mode M5, the human driving force is equal to or less than the normal threshold of the selected group of the level decrease information T2.

The condition regarding the traveling state of the human-powered vehicle 1 is satisfied, for example, in a case where the pitch angle of the human-powered vehicle 1 is equal to or less than a predetermined threshold. The predetermined threshold can change in accordance with the current assist mode.

The condition regarding the traveling environment of the human-powered vehicle 1 is satisfied, for example, in a case where the obliquity of the traveling passage of the human-powered vehicle 1 is equal to or less than a predetermined threshold. The predetermined threshold can change in accordance with the current assist mode.

In the present embodiment, the second traveling condition is satisfied in a case where the condition regarding the human driving force is satisfied. In a case where the second traveling condition is satisfied after the electronic controller 19d changes the assist mode so as to increase the assist level, the electronic controller 19d changes the current assist mode to a changed assist mode determined in accordance with the level decrease information T2.

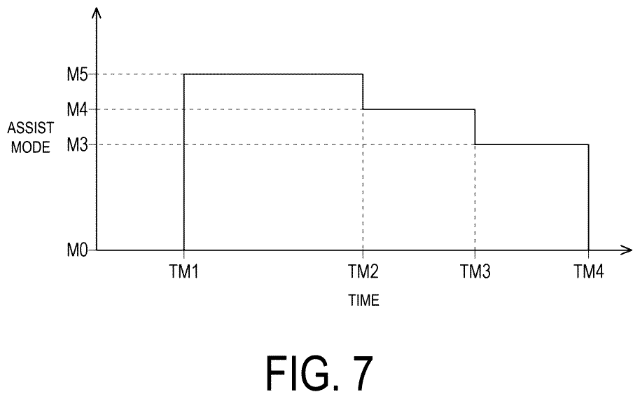

A specific example of the state transition of the drive unit 19 in a case where the assist mode is changed by the electronic controller 19d will be described with reference to FIGS. 4 and 7. A torque rank illustrated in FIG. 4 is a condition of the human driving force for causing the state of the drive unit 19 to transition. In the present embodiment, the torque rank indicates a relationship between each threshold of the selected group of the level increase information T1 or each threshold of the selected group of the level decrease information T2 and the human driving force.

A torque rank 3 indicated by an arrow A1 that extends from the user-designated assist level L0 and returns to the user-designated assist level L0 means that the human driving force is less than the threshold for the medium load of the selected group of the level increase information T1. In a case of the torque rank 3 in the user-designated assist mode M0, the electronic controller 19d determines the increase amount of the assist level to be zero based on the level increase information T1 and maintains the user-designated assist mode M0.

A torque rank 4 indicated by an arrow A2 extending from the user-designated assist level L0 to the third increase level L3 means that the human driving force is less than the threshold for the high load of the selected group of the level increase information T1 and that the human driving force is equal to or greater than the threshold for the medium load of the selected group of the level increase information T1. In a case where the torque rank becomes the torque rank 4 in the user-designated assist mode M0, the electronic controller 19d determines the increase amount of the assist level to be 3 based on the level increase information T1 and changes the assist mode to the third increase mode M3.

The electronic controller 19d can increase the assist level from the user-designated assist level L0 to the third increase level L3 by changing the assist mode to the third increase mode M3. Increasing the assist level can decrease the load on the user during the traveling of the human-powered vehicle 1, and thus the electronic controller 19d can contribute to comfortable traveling of the human-powered vehicle 1.

A torque rank 5 indicated by an arrow A3 extending from the user-designated assist level L0 to the fourth increase level L4 and an arrow A4 extending from the third increase level L3 to the fourth increase level L4 means that the human driving force is less than the threshold for the very high load of the selected group of the level increase information T1 and is equal to or greater than the threshold for the high load of the selected group of the level increase information T1. In a case where the torque rank becomes the torque rank 5 in the user-designated assist mode M0 and the third increase mode M3, the electronic controller 19d changes the assist mode to the fourth increase mode M4.

A torque rank 6 indicated by an arrow A5 extending from the user-designated assist level L0 to the fifth increase level L5, an arrow A6 extending from the third increase level L3 to the fifth increase level L5, and an arrow A7 extending from the fourth increase level L4 to the fifth increase level L5 means that the human driving force is equal to or greater than the threshold for the very high load of the selected group of the level increase information T1. In a case where the torque rank becomes the torque rank 6 in the user-designated assist mode M0, the third increase mode M3, and the fourth increase mode M4, the electronic controller 19d changes the assist mode to the fifth increase mode M5.

In a case of increasing the assist level, the electronic controller 19d directly changes the assist mode from the current assist mode to a changed assist mode not through an intermediate assist mode. For example, in a case where the torque rank becomes the torque rank 5 in the user-designated assist mode M0 at a time TM1 shown in FIG. 7, the electronic controller 19d changes the assist mode to the fifth increase mode M5 not through the third increase mode M3 or the fourth increase mode M4. Since the electronic controller 19d can quickly increase the assist level by changing the assist mode to the fifth increase mode M5 not through the third increase mode M3 or the fourth increase mode M4, it is possible to cope with the user's urgency.

In FIG. 4, a torque rank 2 or less indicated by an arrow A8 extending from the fifth increase level L5 to the fourth increase level L4, arrows A9 and A10 extending from the fourth increase level L4 to the third increase level L3, and arrows A11 and A12 extending from the third increase level L3 to the user-designated assist level L0 means that the human driving force is equal to or less than the normal threshold of the selected group of the level decrease information T2. In a case where the human driving force is equal to or less than the normal threshold at the fifth increase level L5, the electronic controller 19d determines the decrease amount of the assist level to be 5.

In the present embodiment, the electronic controller 19d changes the current assist mode to a changed assist mode having an assist level one level lower than that of the current assist mode regardless of the determined decrease amount of the assist level. In a case where the decrease amount of the assist level is determined to be 5, the electronic controller 19d waits until the crank 10 makes two stroke rotations, as indicted by the fourth increase mode M4 in FIG. 4, and then changes the assist mode from the fifth increase mode M5 to the fourth increase mode M4. For example, the electronic controller 19d detects the rotation of the crank 10 based on a signal from the fourth detector 24 and thus can wait until the crank 10 makes two stroke rotations.

As indicated by the arrow A9, the electronic controller 19d changes the assist mode from the fourth increase mode M4 to the third increase mode M3 in a case where the torque rank is the torque rank 2 or less in the most recent four stroke rotations of the crank 10. In a case where the rotation of the crank 10 in the fifth increase mode M5 is included in the most recent four stroke rotations of the crank 10, the electronic controller 19d excludes the rotation of the crank 10 in the fifth increase mode M5 and determines whether the torque rank is the torque rank 2 or less.

For example, in a case where the electronic controller 19d waits until the crank 10 makes two stroke rotations and then changes the assist mode from the fifth increase mode M5 to the fourth increase mode M4, and the crank 10 makes two stroke rotations, the electronic controller 19d determines whether the torque rank is the torque rank 2 or less in the most recent two stroke rotations of the crank 10. As indicated by the arrow A10, the electronic controller 19d can change the assist mode based on the human driving force in the fourth increase mode M4 by changing the assist mode from the fourth increase mode M4 to the third increase mode M3 in a case where the torque rank is the torque rank 2 or less in the most recent two strokes of the crank 10.

As indicated by the arrows A11 and A12, the electronic controller 19d changes the assist mode from the third increase mode M3 to the user-designated assist mode M0 in a manner similar to the case where the assist mode is changed from the fourth increase mode M4 to the third increase mode M3.

In a case where there is at least one intermediate assist mode having an assist level lower than the assist level of the current assist mode and higher than the assist level of the changed assist mode after the change determined in accordance with the level decrease information T2, the electronic controller 19d changes the current assist mode to the changed assist mode after the change through the intermediate assist mode. For example, in a case where the state of the torque rank 2 or less continues from a time TM2 to the time TM4 later than the time TM1 shown in FIG. 7, the electronic controller 19d changes the assist mode to the user-designated assist mode M0 through the fourth increase mode M4 and the third increase mode M3.

In the present embodiment, the electronic controller 19d changes the assist mode from the fourth increase mode M4 to the third increase mode M3 after the crank 10 makes at least two stroke rotations. After the crank 10 makes at least two stroke rotations, the electronic controller 19d changes the assist mode from the third increase mode M3 to the user-designated assist mode M0.

By changing the assist mode to the user-designated assist mode M0 through the fourth increase mode M4 and the third increase mode M3, the electronic controller 19d can decrease the assist level in a stepwise manner. This enables the user to be less likely to notice the change in the assist mode. By enabling the user to be less likely to notice the change in the assist mode, the electronic controller 19d can allay discomfort given to the user and thus can contribute to comfortable traveling of the human-powered vehicle 1.

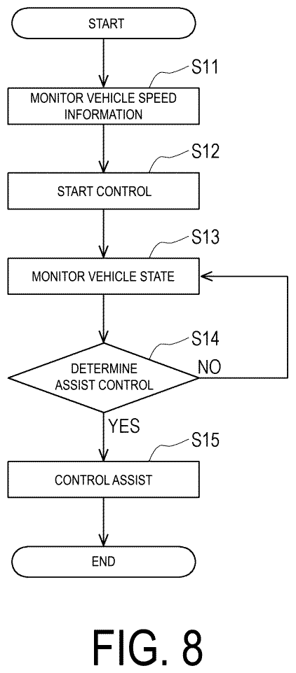

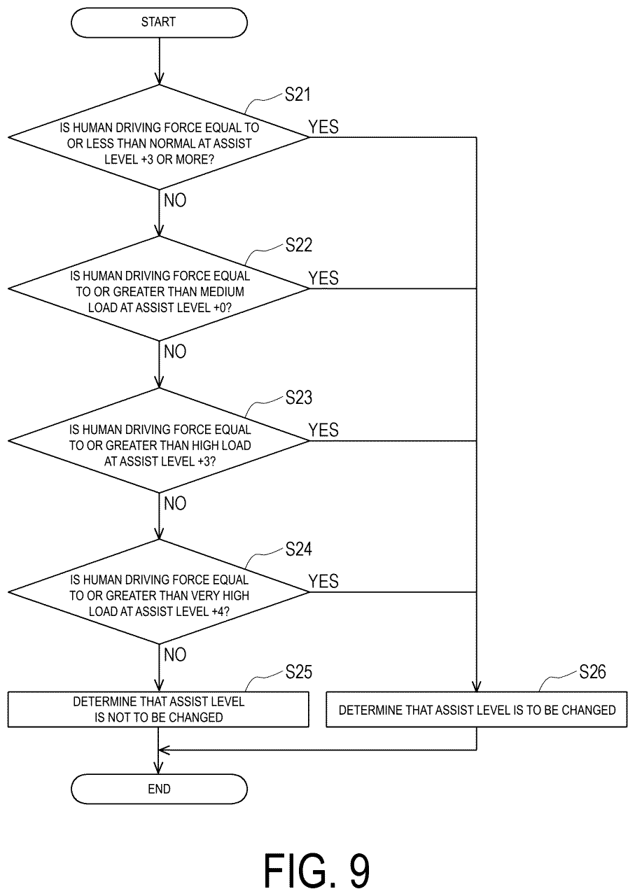

An example of the control performed by the electronic controller 19d will now be described. The example of the control performed by the electronic controller 19d will be described with reference to FIGS. 8 and 9. In a case where a predetermined condition is satisfied, the electronic controller 19d starts a first control flow according to a flowchart illustrated in FIG. 8. In the present embodiment, the electronic controller 19d starts the first control flow in a case where power starts to be supplied from a predetermined power source to the control device 19b. In a case where the first control flow ends, the electronic controller 19d repeatedly performs the first control flow at predetermined intervals until a predetermined condition is satisfied. In the present embodiment, the electronic controller 19d repeatedly performs the first control flow until power is no longer supplied to the control device 19b from the predetermined power source.

In step S11, the electronic controller 19d monitors information regarding the vehicle speed of the human-powered vehicle 1. The electronic controller 19d detects the vehicle speed of the human-powered vehicle 1 based on, for example, a signal from the fourth detector 24. Based on the vehicle speed of the human-powered vehicle 1, the electronic controller 19d detects transition from a state in which the human-powered vehicle 1 travels to a state in which the human-powered vehicle 1 stops. The state in which the human-powered vehicle 1 travels is, for example, a state in which the vehicle speed of the human-powered vehicle 1 is higher than a predetermined speed. The state in which the human-powered vehicle 1 stops is, for example, a state in which the vehicle speed of the human-powered vehicle 1 is equal to or less than the predetermined speed.

For example, in a case where the vehicle speed of the human-powered vehicle 1 changes from a speed higher than 0 kilometers per hour to 0 kilometers per hour, the electronic controller 19d detects transition from the state in which the human-powered vehicle 1 travels to the state in which the human-powered vehicle 1 stops. For example, in a case where the vehicle speed of the human-powered vehicle 1 does not change from a speed higher than 0 kilometers per hour to 0 kilometers per hour, the electronic controller 19d does not detect the transition from the state in which the human-powered vehicle 1 travels to the state in which the human-powered vehicle 1 stops. After performing the processing of step S11, the electronic controller 19d proceeds to step S12.

In step S12, the electronic controller 19d performs start control. The start control is control for increasing the assist level in a case where the human-powered vehicle 1 stops in a state in which at least one of the transmission gear ratio of the human-powered vehicle 1 and the transmission gear stage of the human-powered vehicle 1 is high. In a case where the electronic controller 19d detects, in step S11, the transition from the state in which the human-powered vehicle 1 travels to the state in which the human-powered vehicle 1 stops, the electronic controller 19d monitors at least one of the transmission gear ratio of the human-powered vehicle 1 and the transmission gear stage of the human-powered vehicle 1. The electronic controller 19d changes the assist mode so as to increase the assist level in a case where at least one of the transmission gear ratio and the transmission gear stage of the human-powered vehicle 1 is equal to or greater than a predetermined threshold. For example, the electronic controller 19d changes the assist mode so as not to exceed the range of the increase amount of the assist level defined in the level increase information T1.

In step S12, the electronic controller 19d does not change the assist mode in a case where at least one of the transmission gear ratio and the transmission gear stage of the human-powered vehicle 1 is less than the predetermined threshold. In a case where the electronic controller 19d does not detect, in step S11, the transition from the state in which the human-powered vehicle 1 travels to the state in which the human-powered vehicle 1 stops, the electronic controller 19d does not change the assist mode. After performing the processing in step S12, the electronic controller 19d proceeds to step S13.

In step S13, the electronic controller 19d monitors information regarding the vehicle state. The information regarding the vehicle state includes information for determining whether the first traveling condition and the second traveling condition are satisfied. For example, the electronic controller 19d detects the human driving force based on a signal from the first detector 21. For example, the electronic controller 19d detects at least one of the mean value of the human driving force in a case where the crank 10 rotates a predetermined number of times and the maximum value of the human driving force in the case where the crank 10 rotates the predetermined number of times. After performing the processing in step S13, the electronic controller 19d proceeds to step S14.

In step S14, the electronic controller 19d determines whether or not to control the assist level so as to increase or decrease the assist level based on the human driving force detected in step S13. A sub-flow of step S14 is described in FIG. 9. In a case where the electronic controller 19d performs the processing in step S14, the electronic controller 19d proceeds to step S21.

The electronic controller 19d proceeds to step S26 in a case where, in step S21, the current assist level is equal to or greater than the third increase level L3 and the human driving force detected in step S13 is equal to or less than the normal threshold of the selected group of the level decrease information T2. The electronic controller 19d proceeds to step S22 in a case where at least one of a case where the current assist level is less than the third increase level L3 and a case where the human driving force detected in step S13 is less than the normal threshold is satisfied.

The electronic controller 19d proceeds to step S26 in a case where, in step S22, the current assist level is the user-designated assist level L0 and the human driving force detected in step S13 is equal to or greater than the threshold for the medium load of the selected group of the level increase information T1. The electronic controller 19d proceeds to step S23 in a case where at least one of a case where the current assist level is not the user-designated assist level L0 and a case where the human driving force detected in step S13 is less than the threshold for the medium load is satisfied.

The electronic controller 19d proceeds to step S26 in a case where, in step S23, the current assist level is the third increase level L3 and the human driving force detected in step S13 is equal to or greater than the threshold for the high load of the selected group of the level increase information T1. The electronic controller 19d proceeds to step S24 in a case where at least one of a case where the current assist level is not the third increase level L3 and a case where the human driving force detected in step S13 is less than the threshold for the high load is satisfied.

The electronic controller 19d proceeds to step S26 in a case where, in step S24, the current assist level is the fourth increase level L4 and the human driving force detected in step S13 is equal to or greater than the threshold for the very high load of the selected group of the level increase information T1. The electronic controller 19d proceeds to step S25 in a case where at least one of a case where the current assist level is not the fourth increase level L4 and a case where the human driving force detected in step S13 is less than the threshold for the very high load is satisfied.

In step S25, the electronic controller 19d determines that the assist level is not to be changed. In a case where it is determined in step S25 that the assist level is not to be changed, the electronic controller 19d proceeds from step S14 to step S13 illustrated in FIG. 8.

In step S26 illustrated in FIG. 9, the electronic controller 19d determines that the assist level is to be changed. In a case where it is determined in step S26 that the assist level is to be changed, the electronic controller 19d proceeds from step S14 to step S15 illustrated in FIG. 8.

In step S15, the electronic controller 19d controls the assist level so as to increase or decrease the assist level. In a case where the condition of step S21 illustrated in FIG. 9 is satisfied, the electronic controller 19d determines the decrease amount of the assist level so as to return the assist level to the user-designated assist level L0 and changes the assist level so as to decrease the assist level. In a case where any of the conditions from step S22 to step S24 is satisfied, the electronic controller 19d determines the increase amount of the assist level based on the level increase information T1 and changes the assist level so as to increase the assist level. After performing the processing in step S15, the electronic controller 19d ends the first control flow.

By performing the first control flow, the electronic controller 19d can change the assist level between the user-designated assist level L0, the third increase level L3, the fourth increase level L4, and the fifth increase level L5, as in the state transition diagram illustrated in FIG. 4.

Since the assist level can be changed between the user-designated assist level L0, the third increase level L3, the fourth increase level L4, and the fifth increase level L5, the electronic controller 19d can change the range of the assist level to be changed in accordance with the assist mode selected by the user and thus can finely control the assist level. Since the assist level can be finely controlled, it is possible to apply an optimum assist force to the human-powered vehicle 1, for example, in a case where the human-powered vehicle 1 travels uphill. Thus, the electronic controller 19d can improve comfort in traveling of the human-powered vehicle 1.

Changing the assist level may discomfort the user in some states of the human-powered vehicle 1. Thus, in step S15, the electronic controller 19d does not need to change the assist mode in some states of the human-powered vehicle 1. For example, the electronic controller 19d does not need to change the assist mode in a case where the human-powered vehicle 1 continuously travels at a low speed. For example, in a case where a state in which the vehicle speed of the human-powered vehicle 1 does not exceed a predetermined first threshold continues for a predetermined time, the electronic controller 19d does not need to change the assist mode so as to increase the assist level.

The electronic controller 19d can be configured not to change the assist mode in a case where the human-powered vehicle 1 suddenly turns so that the user is less likely to feel uncomfortable. For example, the electronic controller 19d can be configured not to change the assist mode in a case where at least one of the steering angle and the roll angle of the human-powered vehicle 1 exceeds a predetermined second threshold. For example, the electronic controller 19d does not need to change the assist level so as to increase the assist level in a case where at least one of the steering angle and the roll angle detected based on a signal from the second detector 22 exceeds the second threshold.

The electronic controller 19d does not change the assist mode so as to increase the assist level in a case where at least one of the steering angle and the roll angle of the human-powered vehicle 1 exceeds the second threshold. Thus, the electronic controller 19d can suppress an increase in the assist level in a case where the human-powered vehicle 1 suddenly turns. Since an increase in the assist level can be suppressed in a case where the human-powered vehicle 1 suddenly turns, the electronic controller 19d can suppress a decrease in operability of the human-powered vehicle 1. This enables the user to be less likely to feel discomfort.

Control of at least one of the steering angle and the roll angle of the human-powered vehicle 1 by the electronic controller 19d is not particularly limited. For example, the electronic controller 19d does not need to change the assist level so as to decrease the assist level in a case where at least one of the steering angle and the roll angle exceeds the second threshold.

### Second Embodiment

A control device 19b according to a second embodiment will be described. The control device 19b according to the second embodiment will be described with reference to FIGS. 8, 10 and 11. Configurations common to those of the first embodiment will be denoted by the same reference signs as those of the first embodiment, and redundant descriptions thereof will be omitted.

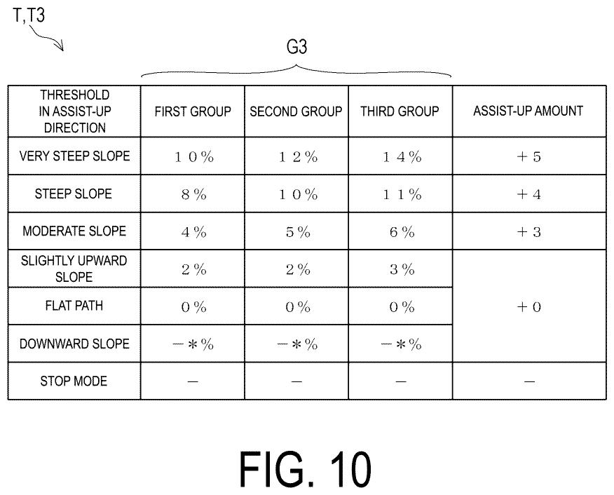

In the present embodiment, an electronic controller 19d is configured to be able to control an assist level in a case where a human-powered vehicle 1 travels uphill, not in a case where a human driving force is large. The electronic controller 19d is configured to control the assist level in accordance with the obliquity of the traveling passage of the human-powered vehicle 1. In a case where the electronic controller 19d controls the assist level in accordance with the obliquity of the traveling passage, level increase information T3 includes, for example, third information regarding the traveling environment of the human-powered vehicle 1 and fourth information regarding the increase amount of the assist level. FIG. 10 shows a specific example of the level increase information T3. The level increase information T3 shown in FIG. 10 is a table for determining the increase amount of the assist level based on the obliquity of the traveling passage.

In FIG. 10, thresholds in an assist-up direction are defined in a stepwise manner in accordance with the load on the user. As the thresholds in the assist-up direction, seven thresholds are separately defined, i.e., a threshold for a very steep slope, a threshold for a steep slope, a threshold for a moderate slope, a threshold for a slightly upward slope, a threshold for a flat path, a threshold for a downward slope, and a threshold for a stop mode. The threshold for the very steep slope is greater than the threshold for the steep slope. The threshold for the steep slope is greater than the threshold for the moderate slope. The threshold for the moderate slope is greater than the threshold for the slightly upward slope. The threshold for the slightly upward slope is greater than the threshold for the flat path. The threshold for the flat path is greater than the threshold for the downward slope. The threshold for the stop mode can be omitted.

The thresholds in the assist-up direction are defined for each of a plurality of groups G3. In the present embodiment, the thresholds in the assist-up direction are defined for each of a first group, a second group, and a third group. The thresholds in the assist-up direction increase in a stepwise manner from the first group toward the third group, except for the threshold for the slightly upward slope, the threshold for the flat path, and the threshold for the downward slope.

An assist-up amount shown in FIG. 10 is defined in a stepwise manner in accordance with the threshold for the very steep slope, the threshold for the steep slope, the threshold for the moderate slope, the threshold for the slightly upward slope, the threshold for the flat path, the threshold for the downward slope, and the threshold for the stop mode. In FIG. 10, the assist-up amount of +0 is associated with the threshold for the downward slope, the threshold for the flat path, and the threshold for the slightly upward slope. In FIG. 10, the assist-up amount of +3 is associated with the threshold for the moderate slope. In FIG. 10, the assist-up amount of +4 is associated with the threshold for the steep slope. In FIG. 10, the assist-up amount of +5 is associated with the threshold for the very steep slope.

The increase amount of the assist level is not limited to the assist-up amount shown in FIG. 10. The increase amounts of the assist level for the threshold for the downward slope, the threshold for the flat path, and the threshold for the slightly upward slope do not need to be set to the same value. The increase amounts can be set to different values for the thresholds in the assist-up direction from the threshold for the downward slope, which has a smallest value, to the threshold for the very steep slope, which has a largest value. The increase amount of the assist level can increase step by step as the threshold increases step by step from the threshold for the downward slope. For example, the increase amount of the assist level can increase one by one as the threshold increases step by step from the threshold for the downward slope.

Level decrease information for decreasing the assist level includes, for example, third information regarding the traveling environment of the human-powered vehicle 1 and fifth information regarding the decrease amount of the assist level. In the level decrease information of the present embodiment, thresholds in an assist-down direction are defined for each of a plurality of groups so as to correspond to the plurality of groups G3 of the level increase information T3. Since the thresholds in the assist-down direction are equal to the thresholds in the assist-up direction of the level increase information T3, illustration of the level decrease information is omitted.

As in the first embodiment, the user can select one group to be compared with the obliquity of the traveling passage from among the first group to the third group by operating at least one of the operation device 31 of the external device 30 and the operation device 20 provided in the human-powered vehicle 1. In the present embodiment, each of the thresholds of an N1-th group of the first group to the third group is set to a numerical value for enabling suitable control of the assist level in a case where the human-powered vehicle 1 travels uphill.

A first traveling condition for increasing the assist level is satisfied in a case where a condition regarding the traveling environment of the human-powered vehicle 1 is satisfied. The condition regarding the traveling environment of the human-powered vehicle 1 is satisfied, for example, in a case where, in a user-designated assist mode M0, the obliquity of the traveling passage is equal to or greater than the threshold for the moderate slope of a selected group selected by the user in the level increase information T3.

The condition regarding the traveling environment of the human-powered vehicle 1 is satisfied, for example, in a case where, in a third increase mode M3, the obliquity of the traveling passage is equal to or greater than the threshold for the steep slope of the selected group of the level increase information T3. The condition regarding the traveling environment of the human-powered vehicle 1 is satisfied, for example, in a case where, in a fourth increase mode M4, the obliquity of the traveling passage is equal to or greater than the threshold for the very steep slope of the selected group of the level increase information T3.

A second traveling condition for decreasing the assist level is satisfied in a case where a condition regarding the traveling environment of the human-powered vehicle 1 is satisfied. The condition regarding the traveling environment of the human-powered vehicle 1 is satisfied, for example, in a case where, in the third increase mode M3, the fourth increase mode M4, and the fifth increase mode M5, the obliquity of the traveling passage is equal to or less than the threshold for the flat path of the selected group of the level decrease information.

The electronic controller 19d can change the assist mode by, for example, performing a second control flow corresponding to the first control flow illustrated in FIG. 8. In the second control flow, the electronic controller 19d performs processing of step S11 and step S12, as in the first control flow. In step S13, the electronic controller 19d detects the obliquity of the traveling passage. In step S14, the electronic controller 19d determines whether or not to control the assist level so as to increase or decrease the assist level based on the obliquity of the traveling passage.

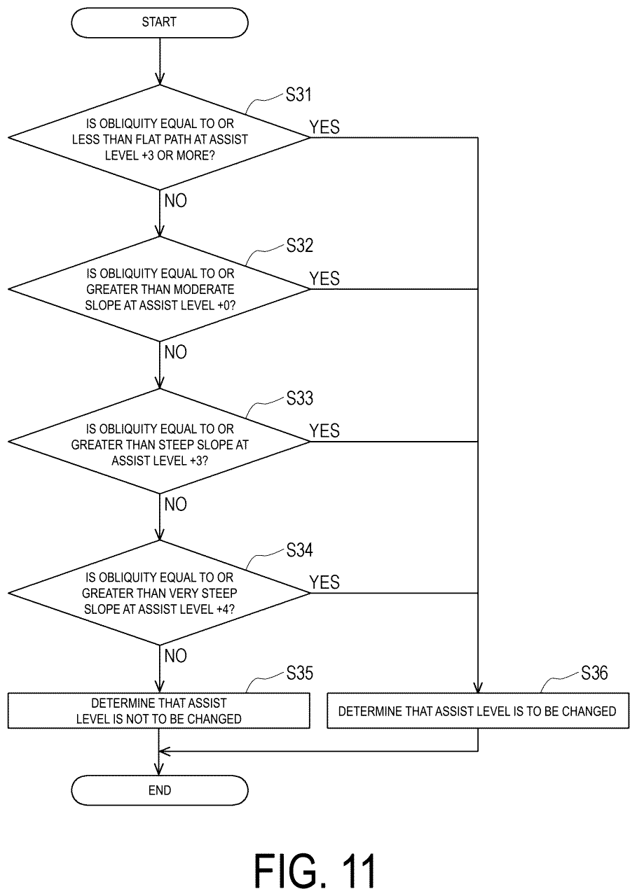

FIG. 11 illustrates an example of a sub-flow of step S14 performed based on the obliquity of the traveling passage. In a case where the sub-flow of FIG. 11 starts, the electronic controller 19d proceeds to step S31.

The electronic controller 19d proceeds to step S36 in a case where, in step S31, the current assist level is equal to or greater than a third increase level L3 and the obliquity of the traveling passage detected in step S13 is equal to or less than the threshold for the flat path of the selected group of the level decrease information. The electronic controller 19d proceeds to step S32 in a case where at least one of a case where the current assist level is less than the third increase level L3 and a case where the obliquity of the traveling passage detected in step S13 is greater than the threshold for the flat path is satisfied.

The electronic controller 19d proceeds to step S36 in a case where, in step S32, the current assist level is a user-designated assist level L0 and the obliquity of the traveling passage detected in step S13 is equal to or greater than the threshold for the moderate slope of the selected group of the level increase information T3. The electronic controller 19d proceeds to step S33 in a case where at least one of a case where the current assist level is not the user-designated assist level L0 and a case where the obliquity of the traveling passage detected in step S13 is less than the threshold for the moderate slope is satisfied.

The electronic controller 19d proceeds to step S36 in a case where, in step S33, the current assist level is the third increase level L3 and the obliquity of the traveling passage detected in step S13 is equal to or greater than the threshold for the steep slope of the selected group of the level increase information T3. The electronic controller 19d proceeds to step S34 in a case where at least one of a case where the current assist level is not the third increase level L3 and a case where the obliquity of the traveling passage detected in step S13 is less than the threshold for the steep slope is satisfied.

The electronic controller 19d proceeds to step S36 in a case where, in step S34, the current assist level is a fourth increase level L4 and the obliquity of the traveling passage detected in step S13 is equal to or greater than the threshold for the very steep slope of the selected group of the level increase information T3. The electronic controller 19d proceeds to step S35 in a case where at least one of a case where the current assist level is not the fourth increase level L4 and a case where the obliquity of the traveling passage detected in step S13 is less than the threshold for the very high load is satisfied.

In step S35, the electronic controller 19d determines that the assist level is not to be changed. In step S36, the electronic controller 19d determines that the assist level is to be changed. In a case where it is determined in step S36 that the assist level is to be changed, the electronic controller 19d controls, in step S15 illustrated in FIG. 8, the assist level so as to increase or decrease the assist level based on the obliquity of the traveling passage detected in step S13.

For example, in a case where the condition of step S31 illustrated in FIG. 11 is satisfied, the electronic controller 19d determines the decrease amount of the assist level so as to return the assist level to the user-designated assist level L0 and changes the assist level so as to decrease the assist level. In a case where any of the conditions from step S32 to step S34 is satisfied, the electronic controller 19d determines the increase amount of the assist level by comparing the threshold for the very steep slope, the threshold for the steep slope, and the threshold for the moderate slope of the selected group of the level increase information T3 with the obliquity of the traveling passage and changes the assist level so as to increase the assist level. After controlling the assist level, the electronic controller 19d ends the second control flow.

By performing the second control flow, the electronic controller 19d enables the assist level to be less likely to decrease in a case where the human-powered vehicle 1 travels uphill and thus can improve comfort in traveling of the human-powered vehicle 1. The electronic controller 19d can control the assist level in accordance with information correlated with the obliquity of the traveling passage. The electronic controller 19d can control the assist level, for example, in accordance with the pitch angle of the human-powered vehicle 1. The electronic controller 19d can control the assist level in accordance with both the obliquity of the traveling passage and the pitch angle.

### Third Embodiment

A control device 19b according to a third embodiment will be described. The control device 19b according to the third embodiment will be described with reference to FIGS. 5, 8, and 12. Configurations common to those of the first embodiment and the second embodiment will be denoted by the same reference signs as those of the first embodiment and the second embodiment, and redundant descriptions thereof will be omitted.

In the present embodiment, an electronic controller 19d is configured to be able to control an assist level both in a case where a human driving force is large and in a case where a human-powered vehicle 1 travels uphill. The electronic controller 19d is configured to control the assist level in accordance with both the human driving force and the obliquity of a traveling passage. The electronic controller 19d can be configured to control the assist level in accordance with the human driving force and the pitch angle of the human-powered vehicle 1.

In a case where the electronic controller 19d controls the assist level in accordance with both the human driving force and the obliquity of the traveling passage, level increase information includes, for example, first information regarding the human driving force, third information regarding the traveling environment of the human-powered vehicle 1, and fourth information regarding the increase amount of the assist level.

In a case where the level increase information includes the first information, the third information, and the fourth information, the electronic controller 19d can determine the increase amount of the assist level based on, for example, the level increase information T1 of the first embodiment shown in FIG. 5 and the level increase information T3 of the second embodiment shown in FIG. 10.

For example, the electronic controller 19d calculates the increase amount of the assist level in accordance with the human driving force based on the level increase information T1 shown in FIG. 5 by the same method as that in the first embodiment. The electronic controller 19d calculates the increase amount of the assist level in accordance with the obliquity of the traveling passage based on the level increase information T3 shown in FIG. 10 by the same method as that in the second embodiment. The electronic controller 19d can use, as the increase amount of the assist level, a larger one of the increase amount of the assist level calculated in accordance with the human driving force and the increase amount of the assist level calculated in accordance with the obliquity of the traveling passage.

Level decrease information includes, for example, first information regarding the human driving force, third information regarding the traveling environment of the human-powered vehicle 1, and fifth information regarding the decrease amount of the assist level. In a case where the level decrease information includes the first information, the third information, and the fifth information, the electronic controller 19d can determine the decrease amount of the assist level based on the level decrease information T2 of the first embodiment shown in FIG. 6 and the level decrease information of the second embodiment.

A first traveling condition for increasing the assist level is satisfied in a case where at least one of a condition regarding the human driving force and a condition regarding the traveling environment of the human-powered vehicle 1 is satisfied. The condition regarding the human driving force is, for example, the same as the first traveling condition of the first embodiment. The condition regarding the traveling environment of the human-powered vehicle 1 is, for example, the same as the first traveling condition of the second embodiment.

A second traveling condition for decreasing the assist level is satisfied in a case where at least one of a condition regarding the human driving force input to the human-powered vehicle 1, a condition regarding the traveling state of the human-powered vehicle 1, and information regarding the traveling environment of the human-powered vehicle 1 is satisfied. In the present embodiment, the second traveling condition is satisfied in a case where both the condition regarding the human driving force and the information regarding the traveling environment of the human-powered vehicle 1 are satisfied. The condition regarding the human driving force is, for example, the same as the second traveling condition of the first embodiment. The condition regarding the traveling environment of the human-powered vehicle 1 is, for example, the same as the second traveling condition of the second embodiment.

The electronic controller 19d can change the assist mode by, for example, performing a third control flow corresponding to the first control flow illustrated in FIG. 8. In the third control flow, the electronic controller 19d performs processing of step S11 and step S12, as in the first control flow. In step S13, the electronic controller 19d detects the human driving force and the obliquity of the traveling passage. In step S14, the electronic controller 19d determines whether or not to control the assist level so as to increase or decrease the assist level based on the human driving force and the obliquity of the traveling passage.

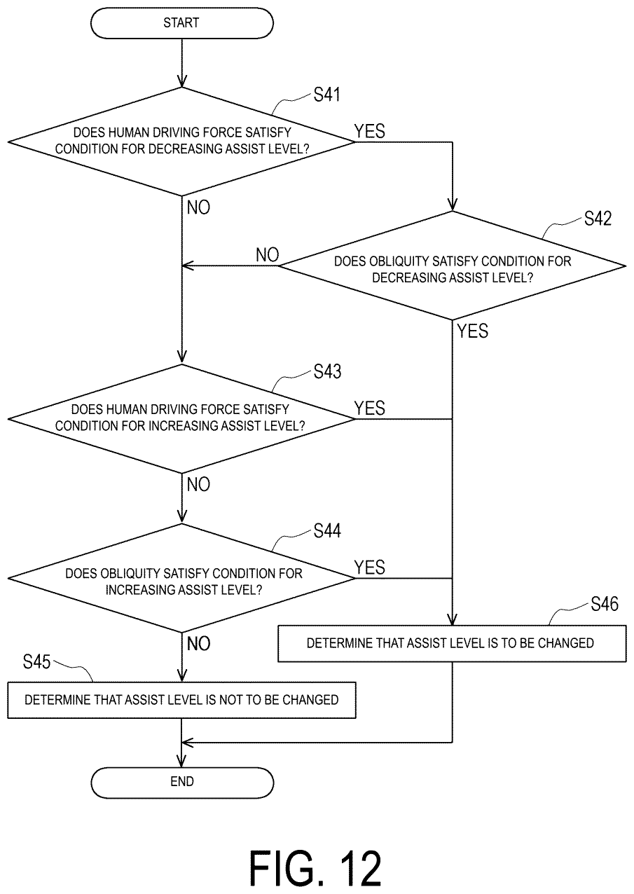

FIG. 12 illustrates an example of a sub-flow of step S14 performed based on the human driving force detected in step S13 and the obliquity of the traveling passage detected in step S13. In a case where the sub-flow of FIG. 12 is performed, the electronic controller 19d proceeds to step S41.

The electronic controller 19d proceeds to step S42 in a case where, in step S41, the human driving force detected in step S13 satisfies a condition for decreasing the assist level. In step S41, the condition for decreasing the assist level is satisfied, for example, in a case where the condition of step S21 of the first embodiment illustrated in FIG. 9 is satisfied. As illustrated in FIG. 12, the electronic controller 19d proceeds to step S43 in a case where the human driving force detected in step S13 does not satisfy the condition for decreasing the assist level.

The electronic controller 19d proceeds to step S46 in a case where, in step S42, the obliquity of the traveling passage detected in step S13 satisfies a condition for decreasing the assist level. In step S42, the condition for decreasing the assist level is satisfied, for example, in a case where the condition of step S31 of the second embodiment illustrated in FIG. 11 is satisfied. As illustrated in FIG. 12, the electronic controller 19d proceeds to step S43 in a case where the obliquity of the traveling passage detected in step S13 does not satisfy the condition for decreasing the assist level.

The electronic controller 19d proceeds to step S46 in a case where, in step S43, the human driving force detected in step S13 satisfies a condition for increasing the assist level. In step S43, the condition for increasing the assist level is satisfied, for example, in a case where at least one of the condition of step S22, the condition of step S23, and the condition of step S24 of the first embodiment illustrated in FIG. 9 is satisfied. As illustrated in FIG. 12, the electronic controller 19d proceeds to step S44 in a case where the human driving force detected in step S13 does not satisfy the condition for increasing the assist level.

The electronic controller 19d proceeds to step S46 in a case where, in step S44, the obliquity of the traveling passage detected in step S13 satisfies a condition for increasing the assist level. In step S44, the condition for increasing the assist level is satisfied, for example, in a case where at least one of the condition of step S32, the condition of step S33, and the condition of step S34 of the second embodiment illustrated in FIG. 11 is satisfied. As illustrated in FIG. 12, the electronic controller 19d proceeds to step S45 in a case where the obliquity of the traveling passage detected in step S13 does not satisfy the condition for increasing the assist level.

In step S45, the electronic controller 19d determines that the assist level is not to be changed. In step S46, the electronic controller 19d determines that the assist level is to be changed. In a case where it is determined in step S46 that the assist level is to be changed, the electronic controller 19d controls, in step S15 illustrated in FIG. 8, the assist level so as to increase or decrease the assist level based on the human driving force detected in step S13 and the obliquity of the traveling passage detected in step S13.

For example, in a case where any of the condition of step S41 and the condition of step S42 illustrated in FIG. 12 is satisfied, the electronic controller 19d determines the decrease amount of the assist level so as to return the assist level to the user-designated assist level L0 and changes the assist level so as to decrease the assist level. In a case where any of the condition of step S43 and the condition of step S44 is satisfied, the electronic controller 19d determines the increase amount of the assist level based on the human driving force detected in step S13 and the obliquity of the traveling passage detected in step S13 and changes the assist level so as to increase the assist level. After controlling the assist level, the electronic controller 19d ends the third control flow.

By performing the third control flow, the electronic controller 19d can decrease the assist level only in a case where both the human driving force detected in step S13 and the obliquity of the traveling passage detected in step S13 satisfy the conditions for decreasing the assist level. Since the assist level can be decreased only in a case where both the human driving force detected in step S13 and the obliquity of the traveling passage detected in step S13 satisfy the conditions for decreasing the assist level, the state in which the assist level is high can be easily maintained until the load on the user becomes light, which can improve comfort in traveling of the human-powered vehicle 1.

### Fourth Embodiment

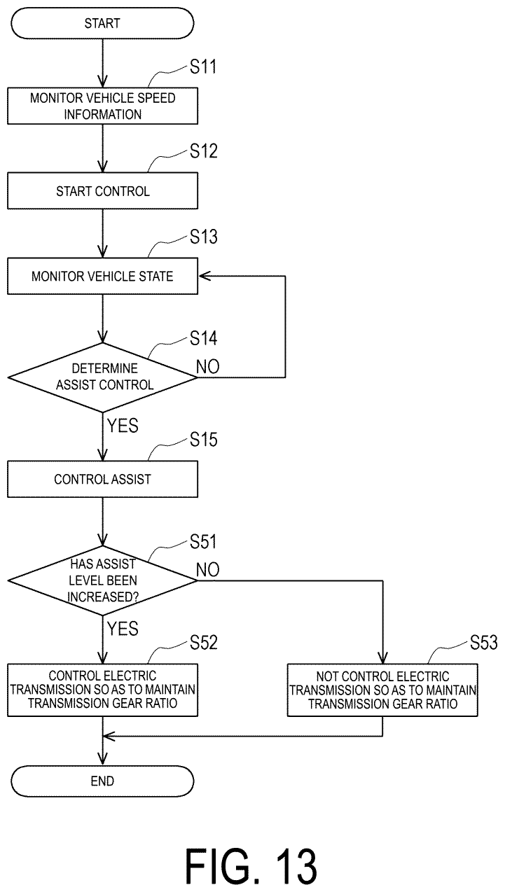

A control device 19b according to a fourth embodiment will be described. The control device 19b according to the fourth embodiment will be described with reference to FIGS. 8 and 13. Configurations common to those of the first to third embodiments will be denoted by the same reference signs as those of the first to third embodiments, and redundant descriptions thereof will be omitted.

In the present embodiment, a human-powered vehicle 1 includes a transmission device controlled to change the transmission gear ratio of the human-powered vehicle 1 in accordance with the traveling state of the human-powered vehicle 1. The traveling state of the human-powered vehicle 1 for changing the transmission gear ratio can be different from the traveling state of the human-powered vehicle 1 in the traveling condition for changing the assist mode. In the present embodiment, an electric transmission 17 included in the transmission device is controlled to change the transmission gear ratio of the human-powered vehicle 1 in accordance with the traveling state of the human-powered vehicle 1. The electric transmission 17 is controlled by, for example, an electronic controller 19d.

The electronic controller 19d controls the electric transmission 17, for example, in accordance with a cadence. For example, in a case where the cadence is equal to or greater than a predetermined threshold, the electronic controller 19d controls the electric transmission 17 so as to perform up-shift transmission. In the present embodiment, the up-shift transmission is an operation of shifting a driving force transmitting portion 16c between a plurality of rear sprockets so as to increase the transmission gear ratio.

For example, in a case where the cadence is less than the predetermined threshold, the electronic controller 19d controls the electric transmission 17 so as to perform down-shift transmission. In the present embodiment, the down-shift transmission is an operation of shifting the driving force transmitting portion 16c between the plurality of rear sprockets so as to decrease the transmission gear ratio.

The electronic controller 19d can suppress an excessive change in the cadence by controlling the electric transmission 17 in accordance with the cadence. A device that controls the electric transmission 17 is not limited to the electronic controller 19d. The electric transmission 17 can be controlled by an electronic controller of a component different from the drive unit 19.

In the present embodiment, the electronic controller 19d is configured to control the transmission device in accordance with the change in the assist mode in a case where the assist mode is changed in accordance with the mode determination information T. In a case where the electronic controller 19d changes the assist mode so as to increase the assist level, the electronic controller 19d controls the transmission device so as to maintain the transmission gear ratio. In the present embodiment, the electronic controller 19d controls the electric transmission 17 so as to suppress the up-shift transmission and the down-shift transmission regardless of the cadence.

An example of the control performed by the electronic controller 19d will now be described. The example of the control performed by the electronic controller 19d will be described with reference to FIG. 13. In a case where a predetermined condition is satisfied, the electronic controller 19d starts a fourth control flow according to a flowchart illustrated in FIG. 13. In a case where the fourth control flow ends, the electronic controller 19d repeatedly performs the fourth control flow at predetermined intervals until a predetermined condition is satisfied. The condition for starting the fourth control flow and the condition for repeating the fourth control flow are similar to those in the first embodiment.

In the fourth control flow, the electronic controller 19d performs processing from step S11 to step S15, as in the first control flow of the first embodiment illustrated in FIG. 8. In step S15, the electronic controller 19d controls the assist level so as to increase or decrease the assist level in accordance with the human driving force detected in step S13.

After performing the processing from step S11 to step S15, the electronic controller 19d proceeds to step S51. In a case where the electronic controller 19d has changed the assist level so as to increase the assist level in step S15, the electronic controller 19d proceeds from step S51 to step S52. In a case where the electronic controller 19d has changed the assist level so as to decrease the assist level in step S15, the electronic controller 19d proceeds from step S51 to step S53.

In step S52, the electronic controller 19d controls the electric transmission 17 so as to maintain the transmission gear ratio regardless of the cadence while the number of rotations of the wheels 15 is 1 to 5. For example, the electronic controller 19d controls the electric transmission 17 so as to maintain the transmission gear ratio regardless of the cadence while the number of rotations of the wheels 15 is 3. After performing the processing in step S52, the electronic controller 19d ends the fourth control flow.

In step S53, the electronic controller 19d does not control the electric transmission 17 so as to maintain the transmission gear ratio regardless of the cadence. After performing the processing in step S53, the electronic controller 19d ends the fourth control flow.

By performing the fourth control flow, the electronic controller 19d can improve the uphill capability of the human-powered vehicle 1. For example, in a case where the human-powered vehicle 1 travels on an upward steep slope, the human driving force is increased, and thus the electronic controller 19d increases the assist level in step S15. The cadence increases with increase in the assist level.

In a case of increasing the assist level, the electronic controller 19d controls the electric transmission 17 so as to maintain the transmission gear ratio. Thus, even in a case where the human-powered vehicle 1 travels on an upward steep slope and the cadence increases with increase in the assist level, the electronic controller 19d can suppress the up-shift transmission. Since the up-shift transmission can be suppressed, the user can easily work the pedals 10c, and thus the electronic controller 19d can improve the uphill capability of the human-powered vehicle 1.

By performing the processing of step S53 of the fourth control flow, the electronic controller 19d can control the electric transmission 17 so as to change the transmission gear ratio in accordance with the cadence in a case of decreasing the assist level. By changing the transmission gear ratio in accordance with the cadence in a case of decreasing the assist level, the electronic controller 19d can quickly operate the electric transmission 17 in accordance with the cadence in a case where the load on the user is light.

A method of controlling the electric transmission 17 in accordance with the change in the assist level is not limited to that of the present embodiment. Since the load on the user can increase in a case where the up-shift transmission is performed, the electronic controller 19d can be configured to suppress at least the up-shift transmission in a case where the assist level is changed. For example, the electronic controller 19d can control the electric transmission 17 so as to suppress the up-shift transmission in at least one of a case of increasing the assist level and a case of decreasing the assist level.

### Modifications

The description with respect to each of the embodiments exemplifies applicable forms of the present invention with no intended limitation. The present invention is applicable to, for example, modifications of each of the embodiments, which are described below, and combinations of at least two modifications that do not contradict each other.

For example, the configuration of the control device 19b according to each of the embodiments is given as one example. The control device 19b can include various types of devices that are not provided in each of the embodiments, or can have a configuration in which some of various types of devices provided in each of the embodiments are not included. For example, the control device 19b can have a configuration in which the wireless communicator 19e illustrated in FIG. 2 is not included. In a case where the wireless communicator 19e is not included, the control device 19b can be configured to communicate with the external device 30 through an electric cable. For example, the electronic controller 19d can be included in a component different from the drive unit 19. For example, the electronic controller 19d can be included in the electric transmission 17.

For example, among the plurality of assist modes M, the electronic controller 19d can exclude a high assist mode having an assist level exceeding a predetermined first level threshold from the assist mode after the change determined in accordance with the mode determination information T. By excluding the high assist mode, the electronic controller 19d enables the assist force to be less likely to excessively increase due to the change in the assist mode, and thus can improve comfort in traveling with the human-powered vehicle 1.

For example, among the plurality of assist modes M, the electronic controller 19d can exclude a low assist mode having an assist level less than a predetermined second level threshold from the assist mode after the change determined in accordance with the mode determination information T. The second level threshold is less than the first level threshold. By excluding the low assist mode, the electronic controller 19d enables the assist force to be less likely to excessively decrease due to the change in the assist mode and thus can improve comfort in traveling of the human-powered vehicle 1.

For example, in a case where the electronic controller 19d changes the assist mode so as to increase the assist level, the electronic controller 19d can increase the assist level in a stepwise manner as in the case of decreasing the assist level.

For example, the electronic controller 19d can control the assist level based on information different from the human driving force and the obliquity of the traveling passage. For example, the electronic controller 19d can control the assist level in accordance with at least one of the vehicle speed of the human-powered vehicle 1, the cadence, and the strength of a headwind in a case where the human-powered vehicle 1 travels forward.

The various thresholds used in the control exemplified in each embodiment are not limited, and can be configured as desired. The various thresholds can be changed as desired by way of operation of a predetermined operation device or the like.

The configurations exemplified in each embodiment can be combined with each other provided that the configurations do not contradict one another. For example, in a case where the configuration described as an example in the first embodiment and the configuration described as an example in the second embodiment are combined and at least one of a case where the human driving force satisfies the condition for decreasing the assist level and a case where the obliquity of the traveling passage satisfies the condition for decreasing the assist level is satisfied, the electronic controller 19d can change the assist mode so as to decrease the assist level.

For example, in a case where the configuration described as an example in the second embodiment and the configuration described as an example in the fourth embodiment are combined and the assist mode is changed such that the assist level increases in accordance with the obliquity of the traveling passage, the electronic controller 19d can control the electric transmission 17 so as to maintain the transmission gear ratio.

For example, in a case where the configuration described as an example in the second embodiment, the configuration described as an example in the third embodiment, and the configuration described as an example in the fourth embodiment are combined and the assist mode is changed such that the assist level increases in accordance with the human driving force and the obliquity of the traveling passage, the electronic controller 19d can control the electric transmission 17 so as to maintain the transmission gear ratio.

The processing contents and the order of processing of the flowcharts illustrated in each embodiment are examples, and the processing contents and the processing order can be changed as appropriate within the scope of the present invention.

The phrase “at least one” as used in this specification means “one or more” of desired options. As one example, in a case where the number of options is two, the phrase “at least one” as used in this specification means “only one option” or “both of two options”. As another example, in a case where the number of options is three or more, the phrase “at least one” as used in this specification means “only one option” or “any combination of two or more options”.

What is claimed is:

1. A control device for a human-powered vehicle, the control device comprising:
an electronic controller configured to control a motor that applies an assist force to the human-powered vehicle in one assist mode of a plurality of assist modes having assist levels different from one another,
the electronic controller being further configured to change a current assist mode to a changed assist mode different from the current assist mode depending on the current assist mode in a case where a traveling condition regarding a traveling state of the human-powered vehicle is satisfied.

2. The control device according to claim 1, wherein
each of the assist levels includes a maximum ratio of an output of the motor to a human driving force input to the human-powered vehicle.

3. The control device according to claim 1, wherein
the electronic controller is configured to change the current assist mode to the changed assist mode in accordance with information regarding the current assist mode and mode determination information.

4. The control device according to claim 3, wherein
the mode determination information includes level increase information for determining the changed assist mode such that the assist level increases.

5. The control device according to claim 4, wherein
the traveling condition includes a first traveling condition satisfied in a case where at least one of a condition regarding a human driving force input to the human-powered vehicle, a condition regarding a traveling state of the human-powered vehicle, and a condition regarding a traveling environment of the human-powered vehicle is satisfied, and
in a case where the first traveling condition is satisfied, the electronic controller is configured to change the current assist mode to the changed assist mode determined in accordance with the level increase information.

6. The control device according to claim 4, wherein
the level increase information includes at least one of first information regarding a human driving force input to the human-powered vehicle, second information regarding a traveling state of the human-powered vehicle, and third information regarding a traveling environment of the human-powered vehicle, and fourth information regarding an increase amount of the assist level.

7. The control device according to claim 6, wherein
the first information includes at least one of information regarding a mean value of the human driving force in a case where a crank of the human-powered vehicle rotates a predetermined number of times and information regarding a maximum value of the human driving force in the case where the crank of the human-powered vehicle rotates the predetermined number of times.

8. The control device according to claim 6, wherein
the second information includes information regarding an inclination of the human-powered vehicle.

9. The control device according to claim 6, wherein
the third information includes information regarding an obliquity of a traveling passage of the human-powered vehicle.

10. The control device according to claim 4, wherein
in a case of increasing the assist level, the electronic controller directly changes the current assist mode to the changed assist mode not through an intermediate assist mode.

11. The control device according to claim 4, wherein
the electronic controller is configured to change the level increase information in accordance with an input from at least one of an operation device of an external device and an operation device provided to the human-powered vehicle.

12. The control device according to claim 4, wherein
the electronic controller is configured not to change the assist mode such that the assist level increases in a case where a state in which a vehicle speed of the human-powered vehicle does not exceed a predetermined first threshold continues for a predetermined time.

13. The control device according to claim 4, wherein
the electronic controller is configured to control a transmission device to maintain a transmission gear ratio of the human-powered vehicle in a case where the assist mode is changed to increase the assist level.

14. The control device according to claim 5, wherein
the mode determination information further includes level decrease information for determining the changed assist mode such that the assist level decreases.

15. The control device according to claim 14, wherein
the traveling condition includes a second traveling condition different from the first traveling condition, and
in a case where the second traveling condition is satisfied after the assist mode is changed such that the assist level increases, the electronic controller is configured to change the current assist mode to the changed assist mode determined in accordance with the level decrease information.

16. The control device according to claim 15, wherein
the second traveling condition is satisfied in a case where at least one of a condition regarding a human driving force input to the human-powered vehicle, a condition regarding a traveling state of the human-powered vehicle, and information regarding a traveling environment of the human-powered vehicle is satisfied.

17. The control device according to claim 14, wherein
the level decrease information includes at least one of first information regarding a human driving force input to the human-powered vehicle, second information regarding a traveling state of the human-powered vehicle, and third information regarding a traveling environment of the human-powered vehicle, and fifth information regarding a decrease amount of the assist level.

18. The control device according to claim 17, wherein
the first information includes at least one of information regarding a mean value of the human driving force in a case where a crank of the human-powered vehicle rotates a predetermined number of times and information regarding a maximum value of the human driving force in the case where the crank of the human-powered vehicle rotates the predetermined number of times.

19. The control device according to claim 17, wherein
the second information includes information regarding an inclination of the human-powered vehicle.

20. The control device according to claim 17, wherein
the third information includes information regarding an obliquity of a traveling passage of the human-powered vehicle.

21. The control device according to claim 14, wherein
the electronic controller is configured to change the current assist mode to the changed assist mode through an intermediate assist mode in which the assist level of the intermediate assist mode is lower than the assist level of the current assist mode and higher than the assist level of the changed assist mode in accordance with the level decrease information.

22. The control device according to claim 14, wherein
the electronic controller is configured to change the level decrease information in accordance with an input from at least one of an operation device of an external device and an operation device provided to the human-powered vehicle.

23. The control device according to claim 1, wherein
the electronic controller is configured not to change the assist mode in a case where at least one of a steering angle and a roll angle of the human-powered vehicle exceeds a predetermined second threshold.
